(19) United States
(12) Patent Application Publication
(10) Pub. No.: US 2026/0126635 A1
(43) Pub. Date: May 7, 2026

(54) PROGRAMMABLE SWITCHING MODULE COMPOSED OF DIGITAL MICROMIRROR DEVICE (DMD) AND MICROLENS ARRAY FOR HIGH-SPEED AND MULTIPLEXED SWITCHING OF ILLUMINATION ANGLES

(71) Applicant: BOARD OF REGENTS, THE UNIVERSITY OF TEXAS SYSTEM, Austin, TX (US)

(72) Inventors: Shwetadwip Chowdhury, Austin, TX (US); Siqi Yang, Austin, TX (US)

(21) Appl. No.: 19/377,482

(22) Filed: Nov. 3, 2025

Related U.S. Application Data
(60) Provisional application No. 63/715,044, filed on Nov. 1, 2024.
(60) Provisional application No. 63/793,262, filed on Apr. 23, 2025.

(51) Int. Cl. G02B 21/00; G02B 5/02; G02B 6/293; G02B 21/36

(52) U.S. Cl. CPC G02B 21/0048; G02B 5/0294; G02B 6/2938; G02B 21/006; G02B 21/361

(57) ABSTRACT

Embodiments of the present disclosure provide three-dimensional (3D) imaging systems and methods. In one example, a non-interferometric ODT system is provided that utilizes a fully-switchable angle scanning component/module, composed of a digital micromirror device (DMD) and microlens array (MLA). The example system allows completely independent generation of each illumination angle or imaging configuration while also optimizing its power efficiency based on the density of illumination angles.

### CROSS-REFERENCE TO RELATED APPLICATIONS

This application claims priority to and the benefit of U.S. Provisional Application No. 63/715,044, filed on Nov. 1, 2024, and U.S. Provisional Application No. 63/793,262, filed on Apr. 23, 2025, the contents of which are incorporated by reference herein in their entireties.

### BACKGROUND

Optical diffraction tomography (ODT) provides label-free, morphological three-dimensional (3D) imaging of biological samples by utilizing refractive-index (RI) contrast. This technique typically requires illumination of the sample at several hundred angles. The angular-specific scattering measurements capture 3D information about the sample's RI, which is then computationally reconstructed. This whole process relies on the ability to illuminate the sample at several hundred directions within the time-scale of the sample's natural biological dynamics. ODT systems typically employ scanning mirrors or light emitting diode (LED) arrays to generate angular illuminations. However scanning mirrors are intrinsically slow due to their inertial and mechanical instabilities and constrain the sample to being illuminated with only one angled beam at a time. Furthermore, LED arrays have low power, and thus require long integration time during data acquisition, which also limits speed. Thus, ODT systems are currently limited to only slow-moving samples.

What are needed are systems and methods that enable and support real time ODT imaging at high data acquisition speeds.

### SUMMARY

Disclosed are computer-implemented methods, systems, and apparatuses for generating 3D images, including a light delivery component that is capable of illuminating a sample with multiple angled plane waves simultaneously. An example system can further include a fully-switchable angle scanning component operatively coupled to the light delivery component configured to scan the illuminated sample at a plurality of illumination angles or imaging configurations simultaneously, and an imaging component configured to capture a plurality of two-dimensional (2D) images at each of the plurality of illumination angles or imaging configurations.

In some implementations, a three-dimensional (3D) imaging system is provided. The system can include: a light delivery component configured to condition a light beam to illuminate a sample with multiple angled plane waves simultaneously; a fully-switchable angle scanning component operatively coupled to the light delivery component configured to scan the illuminated sample at a plurality of illumination angles or imaging configurations simultaneously; an imaging component configured to capture a plurality of two-dimensional (2D) images at each of the plurality of illumination angles or imaging configurations; and at least one processor configured to: determine, using a layer-by-layer decomposition operation and based, at least in part, on 3D refractive index initial guess, one or more transmittance properties (e.g., propagation kernel and complex transmittance) including a transmittance magnitude and phase shift as the light beam passes through the sample at each of the plurality of illumination angles or imaging configurations, simulate 2D acquisition images based on the one or more transmittance properties, and reconstruct 3D refractive index to generate a 3D image of the sample by iteratively minimizing a difference between the simulated 2D images and the captured 2D images.

In some implementations, the at least one processor is further configured to: reconstruct the 3D refractive index to generate the 3D image by iteratively applying a multi-slice beam propagation (MSBP) or MSBP forward model operation.

In some implementations, the at least one processor is further configured to attenuate noise and poor conditioning by: implementing a 3D total-variation (TV) regularization operation.

In some implementations, the light delivery component includes: at least one of a rotating diffuser; at least one focusing lens; and a multimode fiber operatively coupled to one or more vibrational motors.

In some implementations, the at least one rotating diffuser is configured to scatter the light beam, and the at least one focusing lens is configured to collect the scattered light beam and focus it into the multimode fiber.

In some implementations, the multimode fiber is configured to scramble or further disperse the scattered/focused light beam using the one or more vibrational motors.

In some implementations, the fully-switchable angle scanning component includes a digital micromirror device (DMD) element and a microlens array.

In some implementations, the DMD element includes a plurality of micromirrors that are each configured to switch between an on-state and an off-state.

In some implementations, in an on-state, a respective subset of the plurality of micromirrors is configured to generate a focal point on a corresponding location of the microlens array at one or more predetermined angles.

In some implementations, the one or more predetermined angles include between two and twenty predetermined angles.

In some implementations, each respective subset includes a plurality of micromirror patches that each, in the on-state, generates a respective focal point on a single microlens of the microlens array.

In some implementations, each of the plurality of micromirror patches is circular.

In some implementations, scanning the illuminated sample at a plurality of illumination angles or imaging configurations includes multiplexing the plurality of illumination angles by simultaneously switching through the plurality of micromirror patches.

In some implementations, each respective subset of the plurality of micromirrors is activated sequentially.

In some implementations, the at least one processor is further configured to: calibrate incident angles of the plane wave illumination beams using an angle-calibration operation.

In some implementations, a method is provided. The method can include: illuminating a sample with a light beam, wherein the light beam is delivered by a light delivery component; scanning, via a fully-switchable angle scanning component, the illuminated sample at a plurality of illumination angles or imaging configurations simultaneously; capturing, via an imaging component, a plurality of two-dimensional images at each of the plurality of illumination angles or imaging configurations; determining, using a layer-by-layer decomposition operation and based, at least in part, on 3D refractive index initial guess, one or more transmittance properties (e.g., propagation kernel and complex transmittance) including a transmittance magnitude and phase shift as the light beam passes through the sample at each of the plurality of illumination angles or imaging configurations; simulating 2D acquisition images based on the one or more transmittance properties; and reconstructing 3D refractive index to generate a 3D image of the sample by iteratively minimizing a difference between the simulated 2D images and the captured 2D images.

In some implementations, the method further includes: implementing, by the at least one processor, a 3D total-variation (TV) regularization operation to attenuate noise and poor conditioning.

In some implementations, another three-dimensional (3D) imaging system is provided. The system can include a light delivery component configured to condition a light beam to illuminate a sample with multiple angled plane waves simultaneously; a fully-switchable angle scanning component operatively coupled to the light delivery component configured to scan the illuminated sample at a plurality of illumination angles or imaging configurations simultaneously; and an imaging component configured to capture a plurality of two-dimensional (2D) images at each of the plurality of illumination angles or imaging configurations, wherein the light delivery component includes at least one of a rotating diffuser, at least one focusing lens, and a multimode fiber operatively coupled to one or more vibrational motors.

In some implementations, the at least one rotating diffuser is configured to scatter the light beam, and the at least one focusing lens is configured to collect the scattered light beam and focus it into the multimode fiber.

In some implementations, the multimode fiber is configured to scramble or further disperse the scattered/focused light beam using the one or more vibrational motors.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A is a flowchart of an example method in accordance with certain embodiments of the present disclosure.

FIG. 1B illustrates the computational design in accordance with certain embodiments of the present disclosure.

FIG. 2A shows an example light delivery component in accordance with certain embodiments of the present disclosure.

FIG. 2B shows an example system in accordance with certain embodiments of the present disclosure.

FIG. 3A shows an optical schematic in accordance with certain embodiments described herein.

FIG. 3B shows an exemplary non-interferometric imaging system in accordance with certain embodiments described herein.

FIG. 3C shows an exemplary illumination module in accordance with certain embodiments described herein.

FIG. 3D illustrates different illumination configurations with tunable coherent source.

FIG. 3E illustrates polymethyl methacrylate (PMMA) microsphere reconstruction and corresponding line profile with different illumination configurations.

FIG. 4A, FIG. 4B, and FIG. 4C show experimental results from a study that was conducted.

FIGS. 5A-5J show 3D RI of microspheres after imaging with low and high NA, simulated by Fourier filtering with NA-dependent OTF from a study that was conducted.

FIGS. 6A-6J show experimental results from a study that was conducted.

FIGS. 7A-7F demonstrate 3D RI reconstruction of a 24 hpf zebrafish embryo tail.

FIG. 8. is an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

The following description of the disclosure is provided as an enabling teaching of the disclosure in its best, currently known embodiment(s). To this end, those skilled in the relevant art will recognize and appreciate that many changes can be made to the various embodiments of the present disclosure, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Reference will now be made in detail to the embodiments of the present disclosure, examples of which are illustrated in the drawings and the examples. The present disclosure may, however, be embodied in many different forms and should not be construed as limited to the embodiments set forth herein.

### Terminology

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

The following definitions are provided for the full understanding of terms used in this specification.

The terms “about” and “approximately” are defined as being “close to” as understood by one of ordinary skill in the art. In one non-limiting embodiment the terms are defined to be within 10%. In another non-limiting embodiment, the terms are defined to be within 5%. In still another non-limiting embodiment, the terms are defined to be within 1%.

As used herein, the terms “may,” “optionally,” and “may optionally” are used interchangeably and are meant to include cases in which the condition occurs as well as cases in which the condition does not occur.

The refractive index (RI) is an intrinsic optical property widely used in label-free imaging, offering biophysical contrast along with quantitative information. A prominent technique for volumetric RI imaging is optical diffraction tomography (ODT). Traditional ODT relies on the weak scattering assumption and can effectively reconstruct relatively simple samples, such as a monolayer of cells. However, this assumption breaks down for samples with larger sizes or greater RI variations. To address this, various multiple scattering models have been developed to enable reconstruction of more complex samples, such as multislice beam propagation method (MSBP), multi-layer Born (MLB) et al.

These inverse-scattering methods typically require the sample to be illuminated from multiple angles, or positioned in different orientations or focal planes to acquire 3D information, which means multiple measurements are needed for one volumetric reconstruction. Standard imaging pipelines assume the sample remains stationary throughout this process. As a result, the temporal resolution of a 3D time-lapse video is constrained by the total time required to acquire all 2D measurements for one volumetric frame.

There are two ways to increase the volumetric imaging speed. One is to enable faster scanning speed for each measurement and there have been some hardware developments to generate sequential angular plane wave illuminations with up to kilohertz scale, such as using the high speed galvo mirrors, LED arrays, Spatial light modulators (SLM), and digital micromirror devices (DMD). A volumetric imaging speed of around 10 Hz can be achieved, but with only around 10 illumination angles. However, as the sample's complexity and scattering increase, the number of the required measurements under different illuminations must increase, to be from hundreds to thousands frames, to obtain a 3D reconstruction of high resolution and high contrast. Because most multiple scattering models are optimization-based, they require increased data redundancy to handle more ill-posed conditions.

This leads to the other way to increase the volumetric imaging speed—to illuminate the sample at multiple angles at a time, with more angular information in fewer measurements. This requires 1) a hardware system that can create multiplexed angled illuminations with high speed, 2) a multiple scattering algorithm to solve the inverse problem from multiplexed measurements. There have been some works using LED arrays to image multiple scattering samples with angle multiplexing strategy. Zhu et al proposed a non-paraxial multiple scattering model and used a multiplexing factor of six LEDs to reconstruct C. Elegans embryos. Sun et al applied multi-slice Rytov model and designed a radial illumination pattern and realized a volumetric imaging speed of higher than 1 Hz. However, these reconstructions have limited contrast. This may be due to the partial coherence of LEDs, which will cause model mismatch with the forward model based on coherent propagation. Furthermore, these LED array based systems have tradeoffs among power, illumination NA, spatial coherence and density of illuminations angles. There have been other works using laser as the illumination source and use digital micromirror devices (DMD) to generate angle-multiplexed illuminations. However, in these works, the scattered field information for each angle is extracted by applying filters in the frequency domain, which can cause artifacts in the reconstruction and is not applicable for multiple scattering samples.

To address these problems, we have developed an ODT imaging system based on DMD and microlens array (MLA). This imaging system has multiple advantages. First, there is no physical scanning involved in the system and the scanning frame rate can be as high as 10 kHz. Also, a laser-based illumination module with tunable spatial coherence is used to reduce the model mismatch. More importantly, this DMD-MLA module enables illuminating the sample with multiple angled plane waves simultaneously. Since the DMD pixels and microlenses that control each illumination angle are independent, this system has the ability to generate flexible multiplexed illumination patterns without crosstalk between each angle. In this work, we use this DMD-MLA based system to multiplex illuminations to reduce the total number of measurements. We design an angle multiplexing algorithm based on MSBP to enable RI reconstruction for multiple scattering samples with multiplexed measurements. We create two different angle multiplexed patterns, one by multiplexing the adjacent angles and the other by multiplexing random angles. To demonstrate the imaging capability of the angle multiplexing strategy, we first verify the quantitative accuracy of the RI reconstruction on microspheres, and then reconstruct some multiple scattering biological samples.

Optical diffraction tomography (ODT) enables label-free and morphological 3D imaging of biological samples using refractive-index (RI) contrast. To accomplish this, ODT systems typically capture multiple angular-specific scattering measurements, which are used to computationally reconstruct a sample's 3D RI. Standard ODT systems employ scanning mirrors to generate angular illuminations. However, scanning mirrors are limited to illuminating the sample from only one angle at a time. Furthermore, when operated at high speeds, these mirrors may exhibit mechanical instabilities that compromise image quality and measurement speed. Here, we developed a novel non-interferometric ODT system that utilizes a fully switchable module for angle scanning, composed of a digital micromirror device (DMD) and microlens array (MLA). We validate the quantitative imaging capability of this system using calibration microspheres. We also demonstrate its capability for imaging multiple-scattering samples by imaging an early-stage zebrafish embryo.

Three-dimensional microscopy has a central role in the biosciences, and enables high-resolution imaging of subcellular structures within the 3D context of their cellular or multicellular environments. Fluorescence imaging has emerged as a major tool for 3D molecular-specific microscopy, but is limited by photobleaching and phototoxicity, which limit capabilities for time-lapse imaging [1, 2]. In contrast, label-free microscopy enables quantitative-and endogenous-contrast imaging, with virtually zero phototoxicity and no photobleaching [3, 4]. Within the domain of 3D label-free imaging, optical diffraction tomography (ODT) has emerged as a powerful class of techniques that uses a biological sample's scattering information to reconstruct its 3D RI. A popular method is to collect the sample's angular scattering information by using motorized tilting mirrors [5-9] to rapidly scan the angle of an illumination beam incident to the sample. However, scanning mirrors can illuminate the sample with only one angled beam at a time. Because ODT often requires more than a hundred angled illumination directions, these scanning mirrors must be operated at high speeds when imaging dynamic samples. At such speeds, movement inertia becomes a limiting factor that can potentially lead to mechanical instabilities. Especially in the case of ODT systems that utilize off-axis interferometry, these instabilities can lead to phase disruptions that degrade the quality of the reconstructed image.

Recent works have also achieved ODT by using computational non-interferometric phase-retrieval methods that do not rely on mechanically scanning mirrors [10-16]. Many of such works often leverage programmable LED arrays as an alternative method to angularly illuminate [17-22] the sample. In such systems, measurements of the sample being illuminated at different angles can be obtained simply by activating individual LEDs within the array, each positioned differently relative to the sample. Compared with mechanically scanning mirrors, LED arrays have faster and more stable switching speeds, and do not contend with inertia. Furthermore, because LEDs can be independently activated, LED arrays enable simultaneous multiplexing of various illumination angles onto the sample [16, 23-25]. Lastly, partially coherent LED light enables speckle-free measurements, while still retaining sufficient coherence for ODT reconstruction.

Unfortunately, speed of data acquisition remains limited due to the inherent low power of LEDs, which necessitate long integration times. With planar LED arrays, this challenge is compounded by the non-uniform distribution of illumination power across varying angles, which results from the unequal distances between the sample and the individual LEDs. While quasi-hemispherical LED arrays [23, 26, 27] provide more uniform power distribution across larger illumination angles, they too are unable to fully overcome the intrinsic power limitations associated with LEDs. Recently, Sun et al. implemented a multiplexed illumination strategy for data acquisition, which increases the total illumination power by simultaneously activating multiple LED elements. However, even with this approach, the achieved data-acquisition speed of approximately 1 Hz is not sufficient for real-time live cell imaging. In a separate study, Li et al. [22] accomplished real-time volumetric imaging of live C. elegans, achieving a total volumetric imaging speed of 10.6 Hz. However, this fast acquisition speed was achieved at the expense of dramatically reducing the number of measurements, which potentially limits the capability to image complex multiple-scattering samples.

To address these issues, pixel-switchable elements that operate at high switching speeds up to tens of kilohertz, such as spatial light modulators (SLM) and digital micromirror devices (DMD), can be used to programmatically and at a per-pixel level modulate high-power laser light. One popular method is to display binary Lee holograms on these switchable devices, which are positioned at a conjugate plane to the sample. This design can achieve either structured illumination (SI) [28, 29] or angular plane-wave illumination [30, 31]. A challenge with this method is that binary hologram patterns result in multiple diffraction orders at the back focal plane of imaging lens, which can deteriorate image quality. There have been different approaches to eliminate this high-order diffraction noise. For instance, Lee et al. used time-multiplexing to generate time-averaged sinusoidal patterns from binary DMD patterns. However, time-multiplexing across various binary patterns dramatically decreases the effective acquisition speed from the DMD's native switching speed. To avoid time-multiplexing, Shin et al. utilized a custom-made, physical iris at the back-focal-plane (BFP) of the imaging lens to block out the spurious diffraction orders. However, only pre-fixed illumination angles were able to pass through this iris, preventing versatile control of illumination angles. Later work by Jin et al. [31] used a second DMD as a fully pixel-addressable iris to dynamically remove spurious diffraction orders from the first DMD. Furthermore, He et al. later showed that this method can also be used to simultaneously illuminate with multiple angles, enabling dramatic increases in acquisition speeds via angle multiplexing. To accomplish this, however, multiple binary patterns must be superimposed, which dramatically increases the number of spurious diffraction orders to a level beyond what can be easily averaged out or physically blocked. Thus, this method for angle-multiplexing would be difficult to scale to an arbitrary number of illumination angles. Furthermore, using a second DMD increases the complexity and cost of the imaging system.

Notably, the methods described previously utilized optical designs where the plane of the switchable element was image-conjugated directly to the sample plane. An alternative strategy is to conjugate the plane of the pixel-switchable element to the back-focal-plane (BFP) of the illumination lens, which corresponds to the Fourier space of the sample. By switching on only a small patch of pixels within the switchable element, a pseudo-focal-spot at the BFP will be generated, resulting in tilted planar waves within the sample volume. A key advantage of this configuration is that multiple arbitrary illumination angles can be generated easily and robustly by simply activating various small pixel-patches in the switchable element [33]. In a recent example of this, Brown et al. developed Fourier synthesis optical diffraction tomography (FS-ODT), which used digital-micromirror devices (DMDs) to simultaneously multiplex tens to hundreds of illumination beams onto the sample for a single measurement. Interestingly, Brown et al. showed that activating small patches within the DMD, overlayed with various carrier frequencies, allowed tunable control of the angle and position of the incident illumination field within the sample volume. Combined with a computational framework to iteratively decouple the multiplexed information within measurements, Brown et al. impressively demonstrated kilohertz-scale volumetric imaging speeds, enabling high-speed visualization of 3D diffusion dynamics. However, because the DMD was only sparsely activated, the system configuration of FS-ODT is power inefficient. Thus, to increase signal-to-noise ratio (SNR) of each measurement while maintaining high speeds, multiple beams needed to be multiplexed. This directly leads to a tradeoff between SNR and conditioning of the demultiplex inverse problem. This tradeoff is further affected by the fact that FS-ODT is configured in an off-axis interferometric design, where extracting the sample's amplitude and phase information requires clear visibility of high-frequency off-axis interference fringes. Though Brown et al. demonstrated FS-ODT's application on sparse and weak-scattering samples, it may potentially be challenging to scale FS-ODT to larger, multiple-scattering samples, where the sample's inherent complexity will prevent clear visualization of low SNR off-axis interference fringes, which will further decrease the conditioning of the inverse reconstruction problem.

Here, we develop a novel non-interferometric ODT system that utilizes a fully-switchable, angle-scanning module. Comprised of a DMD element combined with a microlens array (MLA), this module allows for switchable scanning of illumination angles. Unlike the switchable ODT systems described above, this module allows completely independent generation of each illumination angle (i.e., no spurious diffraction orders) while also optimizing its power efficiency based on the density of illumination angles. As a proof-of-concept demonstration, we achieve angle-switching speeds of 125 Hz, limited currently only by the frame-rate of our camera. To demonstrate the performance of our system, we employ weak-scattering [22] and multiple-scattering 3D [35] phase-retrieval methods to reconstruct 3D refractive-index. We evaluate the quantitative imaging capability of our system using polystyrene and silicon dioxide microspheres and showcase our system's biological imaging capability by 3D imaging an early-stage zebrafish embryo, which is notably a non-sparse, multiple-scattering sample.

### Multi-Slice Beam Propagation (MSBP) Forward Model

In some implementations, a MSBP or MSBP forward model can be iteratively applied to reconstruct the 3D refractive index to generate the 3D image.

The object is divided into N layers, and the distance between each layer is Δz. Use [symbol] ₖ (r) to denote the electric field at kth layer, and the beam propagation through each layer can be written recursively as:

$${k}_{} ( r ) = {t}_{k} ( r ) \cdot {Δ z}_{} ( {k - 1}_{} ( r ) ) \qquad ( 1 )$$

where r is the lateral position vector, { [symbol] ₖ (r) |k=1, 2, . . . , N} denotes the electric field at kth layer, and tₖ(r) is the object's kth layer complex transmittance:

$${t}_{k} = exp \{ j ( \frac{2 π}{λ} ) Δ z ( {n}_{k} ( r ) - {n}_{0} ) \} \qquad ( 2 )$$

Where {nₖ(r)|k=1, 2, . . . , N} is the object's kth layer refractive index (RI), λ is the wavelength of the incident beam, and n₀ is the RI of the medium. [symbol] _{Δz} {·} is the mathematical operator to propagate an electric field by distance Δz:

$${Δ z}_{} \{ \cdot \} = \{ exp [ - j Δ z \sqrt{{( \frac{2 π}{λ} )}^{2} - {\vert k \vert}^{2}} ] \cdot ℱ \{ \cdot \} \} \qquad ( 3 )$$

Where k denotes the 2D spatial frequency, [symbol] {·} is the Fourier transform operator and [symbol] {·} is the inverse Fourier transform.

When the object is illuminated with one beam at a time, the incident electric field is a plane wave, [symbol] ₀=exp (jk₀·r), where k₀ denotes the 2D wave vector of the plane wave illumination. After N-layer propagation, the exist electric field is [symbol] _{N}(r). It accounts for the accumulation of the diffraction and multiple-scattering processes that occurred during optical propagation through the sample and contains information about the sample's 3D structure. In an imaging system, the electric field at the camera plane is:

$$E ( r ) = \{ P ( k ) \cdot ℱ [ {- \hat{z}}_{} ( {N}_{} ( r ) ) ] \} \qquad ( 4 )$$

Where P(k) denotes the system's pupil function and \hat{Z} refers to the distance between the plane of [symbol] _{N}(r) and the plane within the object's volume at conjugate focus to the imaging plane of the system. When the imaging system is focused at the center of the object, \hat{Z}=ΔzN/2. With the forward propagation model, for a known object and [symbol] th illumination

$$= exp ( {jk}_{0}^{( ℓ )} \cdot r ) ,$$

the operator [symbol] {·} is used to denote the forward model operation that predicts the electric field at the camera plane:

$$\{ n ( {r}_{3 D} ) \} = {E}^{( ℓ )} ( r ) = \{ P ( k ) \cdot ℱ [ {- \hat{z}}_{} ( ( r ) ) ] \} \qquad ( 5 )$$

where r_{3D}= [symbol] r, k [symbol] is a 3D spatial position vector, such that n(r_{3D})=nₖ(r), k=1,2,3, . . . , N.

### Multiple-Angle Illumination

In angle multiplexing imaging, the object is illuminated with multiple plane waves simultaneously. [symbol] denots the [symbol] th illumination group and i denotes the ith illumination angle within one group, where [symbol] =1, 2, . . . , M and i=1, 2, . . . , m. Therefore, the electric field created by each plane wave at the camera plane can be written as:

$${ℊ}^{( ℓ , i )} \{ n ( {r}_{3 D} ) \} = {ℱ}^{- 1} \{ P ( k ) \cdot ℱ [ {ℋ}_{\hat{z}} ( {𝓎}_{k}^{( ℓ , i )} ( r ) ) ] \} \qquad ( 6 )$$

### Inverse Problem Formulation

The reconstruction framework can be formulated as a least squares minimization that seeks to estimate the sample's 3D RI by minimizing the difference between the measured intensity and predicted intensity:

$$\hat{n} ( {r}_{3 D} ) = {arg min}_{n ( {r}_{3 D} )} {\sum }_{ℓ = 1}^{L} {\sum }_{r} {\vert \sqrt{{I}^{ℓ} ( r )} - \sqrt{{\sum }_{i = 1}^{m} {\vert {ℊ}^{( ℓ , i )} \{ n ( {r}_{3 D} ) \} \vert}^{2}} \vert}^{2} \qquad ( 7 )$$

where [symbol] (r) the measured intensity with [symbol] th illumination group. And the predicted intensity is an incoherent sum over the intensity of [symbol] {n(r_{3D})} by taking the square of its amplitude.

### Reconstruction Framework

An iterative scheme is utilized to interleave back-propagation and gradient descent steps into each iteration. The following steps are taken for the iterative reconstruction:

1. Initialize N-layer reconstruction volume with constant refractive index, nm. This will serve as the initial estimate of n(r_{3D}). Then, initialize the iteration index to d=0.

2. To start a new iteration, increment the iteration index, d←+d+1, and initialize the per-iteration cost function c(d)=0.

3. Randomly choose (without replacement) an illumination group [symbol] , the incident electric fields are

$$= exp ( {jk}_{0}^{( ℓ , i )} \cdot r ) ,$$

where i=1, 2, . . . , m. For each illumination within this group, use the Eq. (6) to calculate electric field at the camera plane [symbol] {n(r_{3D})} and calculate the following terms:

$${A}^{ℓ} = \sqrt{{\sum }_{i = 1}^{m} {\vert \{ n ( {r}_{3 D} ) \} \vert}^{2}} \qquad ( 8 )$$

For each illumination, also use Eq. (1) to calculate the electric field at each layer of the reconstruction volume

$$\{ {𝓎}_{k}^{( ℓ , i )} ( r ) \vert k = 1 , 2 , … , N \} .$$

4. Increment the cost function for the current iteration:

$$c ( d ) ← c ( d ) + {\sum }_{r} {\vert \sqrt{{I}^{ℓ} ( r )} - {A}^{ℓ} \vert}^{2} \qquad ( 9 )$$

5. Initialize a residual term denoted by

$${𝓆}_{N + 1}^{ℓ} ( r ) .$$

The variable q₀ below is used only for notational simplicity

$${𝓆}_{0}^{( ℓ , i )} ( r ) = {ℊ}^{( ℓ , i )} \{ n ( {r}_{3 D} ) \} - {ℊ}^{( ℓ , i )} \{ n ( {r}_{3 D} ) \} \cdot \frac{\sqrt{{I}^{ℓ} ( r )}}{{A}^{ℓ}} \qquad ( 10 )$$

$${𝓆}_{N + 1}^{( ℓ , i )} ( r ) = {ℋ}_{\hat{z}} [ {ℱ}^{- 1} \{ \overline{P ( k )} \cdot ℱ [ {𝓆}_{0}^{( ℓ , i )} ( r ) ] \} ] \qquad ( 11 )$$

6. For each layer of the reconstruction volume occupied by the sample, compute the back-propagation term

$${S}_{k}^{( ℓ )} ( r ) ,$$

by recursively propagating backwards (i.e. k=N, (N−1), . . . ,1),

$${S}_{k}^{( ℓ , i )} ( r ) = ( - j \frac{2 π Δ z}{λ} ) \cdot \overline{{t}_{k} ( r )} \cdot \overline{{ℋ}_{Δ z} \{ {𝓎}_{k}^{( ℓ , i )} ( r ) \}} \cdot {𝓆}_{k + 1}^{( ℓ , i )} ( r ) \qquad ( 12 )$$

$${𝓆}_{k}^{( ℓ , i )} ( r ) = {ℋ}_{- Δ z} \{ \overline{{t}_{k} ( r )} \cdot {𝓆}_{k + 1}^{( ℓ , i )} ( r ) \} \qquad ( 13 )$$

$${n}_{k} ( r ) ← {n}_{k} ( r ) - α \cdot {\sum }_{i = 1}^{m} {S}_{k}^{( ℓ , i )} ( r ) \qquad ( 14 )$$

where the notation g̅(̅r̅)̅ designates the complex conjugate of a 3D complex-valued variable g(r). Note that Eq. (16) is the gradient descent step for the back-propagation process, where a is a manually-tuned parameter to adjust the step-size.

7. Repeats steps 3-6 for each illumination group [symbol] =1, 2, . . . , M to incrementally refine {nₖ(r)|k=1, 2, . . . , N}, After one round through all the illumination angles is complete, consolidate all of the RI layers into a single 3D RI volume, {nₖ(r)|k=1, 2, . . . , N}=>n(r_{3D}).

8. Implement 3D total-variation (TV) regularization on n(r_{3D}) to stabilize the iterative convergence in the presence of noise and poor conditioning, set by the parameter β,

$$n ( {r}_{3 D} ) ← prox \{ n ( {r}_{3 D} ) , β \} \qquad ( 15 )$$

where the operator prox{ƒ(r_{3D}), γ} is generally defined for some 3D function ƒ(r_{3D}) and parameter γ as:

$$p r o x \{ f ( {r}_{3 D} ) , γ \} = {arg min}_{g ( {r}_{3 D} )} \{ \frac{1}{2} {‖ f ( {r}_{3 D} ) - g ( {r}_{3 D} ) ‖}_{{ℓ}^{2}}^{2} + γ TV [ g ( {r}_{3 D} ) ] \} \qquad ( 16 )$$

### Forward Model

This disclosure provides a inverse-scattering framework based on MBP that reconstructs multiple scattering samples from sequential angular measurements. Here, the algorithm is extended to accommodate angle multiplexed measurements.

The 3D RI distribution of the object can be represented as a 3D array n(r_{3D}), where r_{3D} denotes the 3D spatial vector. Then the 3D object can be divided into multiple 2D slices, and the k-th lateral slice is nₖ(r), where k=1, 2, . . . , N denotes the layer index and r denotes the lateral 2D spatial vector. The axial thickness of each layer is Δz. As light illuminates the object, the electric field will propagate through the object layer be layer. For k-th layer, the input electric field is Eₖ₋₁(r) and the output electric field is Eₖ(r). MSBP models the slice-wise propagation by the following equation:

$${E}_{k} ( r ) = {t}_{k} ( r ) \cdot [ {ℋ}_{Δ z} ( r ) {E}_{k - 1} ( r ) ] \qquad ( {1}^{′} )$$

Where:

$${t}_{k} ( r ) = exp [ j \frac{2 π}{λ} \cdot Δ z \cdot ( {n}_{k} ( r ) - {n}_{0} ) ] \qquad ( {2}^{′} )$$

$${ℋ}_{Δ z} \{ \cdot \} = {ℱ}^{- 1} \{ exp [ - j Δ z \sqrt{{( \frac{2 π}{λ} )}^{2} - {\vert k \vert}^{2}} ] \cdot ℱ \{ \cdot \} \} \qquad ( {3}^{′} )$$

Here, tₖ(r) denotes the 2D complex transmittance of the k-th slice, which encodes the RI variations. λ is the wavelength and n₀ is the medium RI. [symbol] _{Δz}(r) represents the angular spectrum propagation kernel for the distance of Δz, which accounts for the diffraction. [symbol] {·} and [symbol] {·} are the 2D Fourier transform and the inverse Fourier transform operators respectively. k is the 2D lateral spatial frequency vector and Θ is convolution operator. When the object is illuminated with one beam at a time, for the l-th illumination angle, the input electric field at the first layer of the object is a plane wave,

$${E}_{0}^{( l )} ( r ) = exp ( {jk}_{0}^{( l )} \cdot r ) ,$$

where

$${k}_{0}^{( l )}$$

denotes the wave vector for the l-th illumination. After N-layer propagation and recursive calculation based on Eq. (1), the exit electric field at the last layer is

$${E}_{N}^{( l )} ( r ) .$$

In the detection plane of the imaging system, the electric field will be:

$${E}^{( l )} ( r ) = {ℱ}^{- 1} \{ P ( k ) \cdot ℱ [ {ℋ}_{- \hat{z}} [ {E}_{N}^{( l )} ( r ) ] ] \} \qquad ( {4}^{′} )$$

where P(k) is the pupil function of the imaging system, and 2 denotes the distance between the last layer of the object and the focused imaging plane. When the imaging plane is at the center of the object

$$\hat{z} = \frac{N Δ z}{2} .$$

Finally, we use operator [symbol] {·} to denote the forward model operation that predicts the 2D intensity measurement under one illumination based on an initialized object RI:

$${ℊ}^{( l )} \{ n ( {r}_{3 D} ) \} = {\vert {E}^{( l )} ( r ) \vert}^{2} \qquad ( {5}^{′} )$$

In angle multiplexing imaging, all the illumination angles are divided into several groups, and the illuminations within each group will be incident onto the sample simultaneously and formulate one measurement. We use l to denote the index of the illumination group, where l=1, 2, . . . , M, and we use i to denote the index of the illumination angle within one group, where i=1, 2, . . . , m. Therefore, scattering information from M·m different angles will be captured by only M measurements. Similarly, based on the forward model defined above, the predicted intensity measurements for the i-th angle in l-th group can be represented as [symbol] {n(r_{3D})}.

### Inverse Model

The sample will be illuminated under multiple groups of multiplexed angles, and the intensity measurement for each illumination group is l^{(l)}(r), where l=1, 2, . . . , M. The reconstruction framework can be formulated as a least-squares minimization that searches the optimal RI distribution that minimizes the difference between the predicted intensity measurements and the experimental intensity measurements:

$$\hat{n} ( {r}_{3 D} ) = arg {min}_{n ( {r}_{3 D} )} {Σ}_{l = 1}^{M} {Σ}_{{r}_{3 D}} {‖ \sqrt{{I}^{( l )} ( r )} - \sqrt{{Σ}_{i = 1}^{m} \{ n ( {r}_{3 D} ) \}} ‖}_{{l}^{2}}^{2} \qquad ( {6}^{′} )$$

Here, the predicted intensity measurements for each single illumination angle are summed incoherently.

Based on the loss function in Eq. (6), n(r_{3D}) is iteratively optimized using gradient-descent and back-propagation. Here, we show the gradient update step by step within each iteration:

(1) Initialize the N-layer reconstruction volume n(r_{3D}) with a constant RI difference of 0. Initialize the iteration index d=0 and the cost value c(d)=0.

(2) Start the current iteration by incrementing the iteration index d←d+1.

### Reconstruction Framework

(3) Randomly choose the l-th illumination group, and the incident electric fields within this group are

$${E}_{0}^{( l )} ( r ) = exp ( {jk}_{0}^{( l , i )} \cdot r ) ,$$

where i=1, 2, . . . , m. For each illumination angle, use Eq. (6) to calculate the electric field at the camera plane [symbol] {n(r_{3D})} and calculate the following term:

$${A}^{( l )} = \sqrt{{Σ}_{i = 1}^{m} {\vert \{ n ( {r}_{3 D} ) \} \vert}^{2}} \qquad ( {7}^{′} )$$

For each illumination, also use Eq. (1) to calculate the electric field at each layer of the 3D volume

$$\{ {E}_{k}^{( l , i )} ( r ) \vert k = 1 , 2 , … N \}$$

and sum over m angles:

$$\{ {Y}_{k}^{( l )} ( r ) \vert k = 1 , 2 , … N \} = {Σ}_{i = 1}^{m} \{ {E}_{k}^{( l , i )} ( r ) \vert k = 1 , 2 , … N \} \qquad ( {8}^{′} )$$

(4) Update the cost value for the current iteration:

$$c ( d ) ← c ( d ) + {Σ}_{r} {‖ \sqrt{{I}^{( l )}} - {A}^{( l )} ‖}_{{l}^{2}}^{2} \qquad ( {9}^{′} )$$

(5) Initialize a residual term denoted by

$${q}_{0}^{( l , i )}$$

(r).

$${q}_{0}^{( l , i )} ( r ) = \{ n ( {r}_{3 D} ) \} \cdot ( 1 - \frac{\sqrt{{1}^{( l )} ( r )}}{{A}^{( l )}} ) \qquad ( {10}^{′} )$$

$${q}_{N + 1}^{( l , i )} ( r ) = {\hat{Z}}_{} \{ \{ \overline{P ( k )} \cdot ℱ \{ {q}_{0}^{( l , i )} ( r ) \} \} \} \qquad ( {11}^{′} )$$

(6) For each layer of the reconstruction volume occupied by the sample, compute the back propagation term

$${S}_{k}^{( l , i )} ( r ) ,$$

by recursively propagating backwards (i.e. k=N, (N−1), . . . ,1),

$${S}_{k}^{( l , i )} ( r ) = ( - j \frac{2 π Δ z}{λ} ) \cdot \overline{{t}_{k} ( r )} \cdot \overline{{- Δ z}_{} \{ {E}_{k}^{( l , i )} ( r ) \}} \cdot {q}_{k + 1}^{( l , i )} ( r ) \qquad ( {12}^{′} )$$

$${q}_{k}^{( l , i )} ( r ) = {Δ z}_{} \{ \overline{{t}_{k} ( r )} \cdot {q}_{k + 1}^{( l , i )} ( r ) \} \qquad ( {13}^{′} )$$

$${n}_{k} ( r ) ← {n}_{k} ( r ) - α \cdot {Σ}_{i = 1}^{m} {S}_{k}^{( l , i )} ( r ) \qquad ( {14}^{′} )$$

where the notation g̅(̅r̅)̅ designates the complex conjugate of a 3D complex-valued variable g(r). Note that Eq. (14) is the gradient descent step for the back-propagation process, where α is manually-tuned parameter to adjust the step size.

(7) Repeat steps (2)-(6) for each illumination group l=1, 2, . . . , M to incrementally refine {nₖ(r|k=1, 2, . . . , N)}. After one round through all the illumination angles is complete, consolidate all of the RI layers into a single 3D RI volume, {nₖ(r)∥k=1,2, . . . , N}⇒n(r_{3D}).

(8) Implement 3D total-variation (TV) regularization on n(r_{3D}) to stabilize the iterative convergence in the presence of noise and poor conditioning, set by the parameter B,

$$n ( {r}_{3 D} ) ← p r o x \{ n ( {r}_{3 D} ) , β \} \qquad ( {15}^{′} )$$

where the operator prox{f(r_{3D}), γ} is generally defined for some 3D function ƒ(r3D) and parameter y as:

$$p r o x \{ f ( {r}_{3 D} ) , γ \} = arg {min}_{ℊ ( {r}_{3 D} )} \{ \frac{1}{2} {‖ f ( {r}_{3 D} ) - ℊ ( {r}_{3 D} ) ‖}_{{l}^{2}}^{2} + γ TV [ ℊ ( {r}_{3 D} ) ] \} \qquad ( {16}^{′} )$$

### Example Method

Embodiments of the present disclosure provide an inverse-scattering framework based on MSBP that reconstructs multiple scattering samples from sequential angular measurements and extend the proposed algorithm to accommodate angle multiplexed measurements.

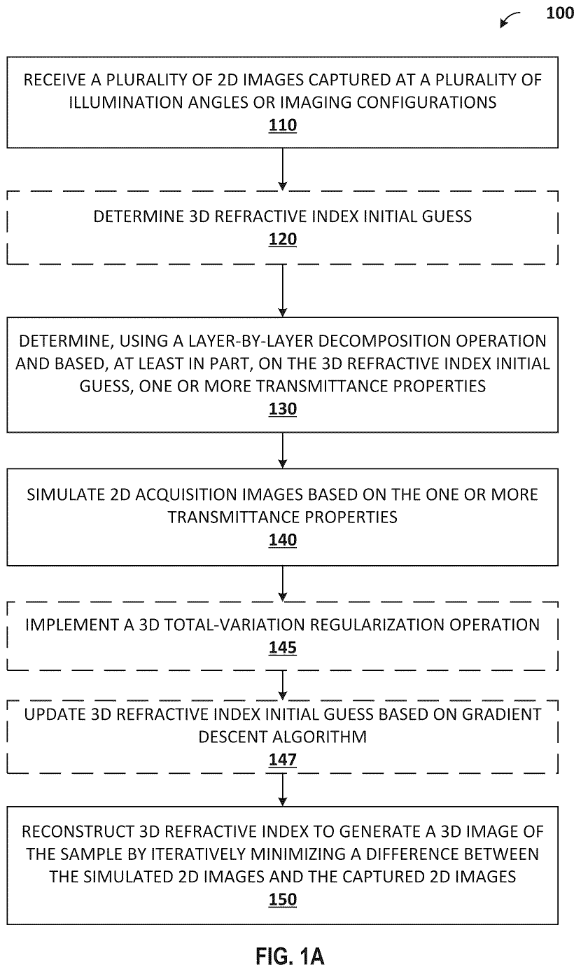

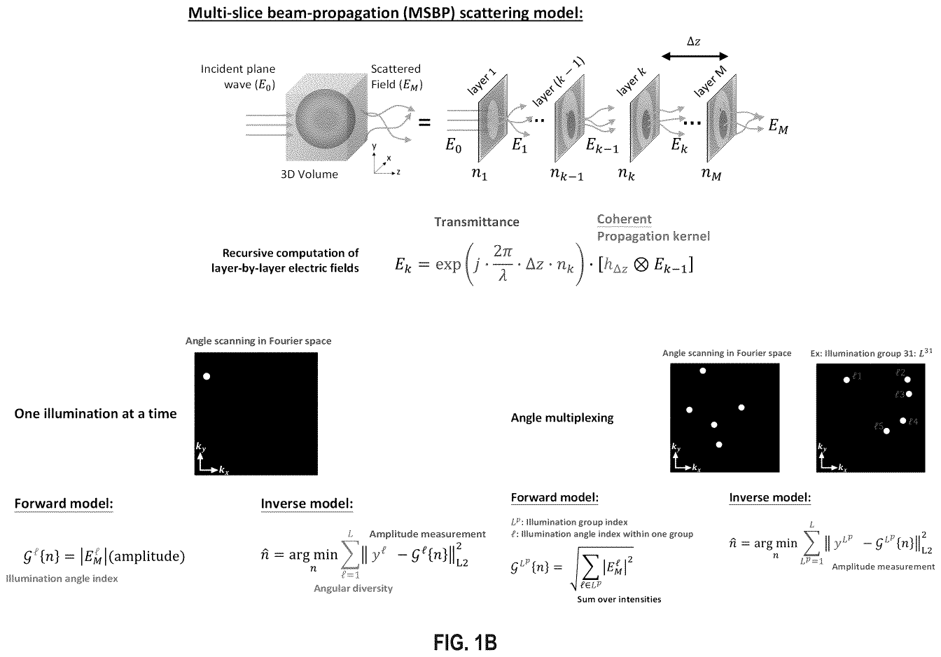

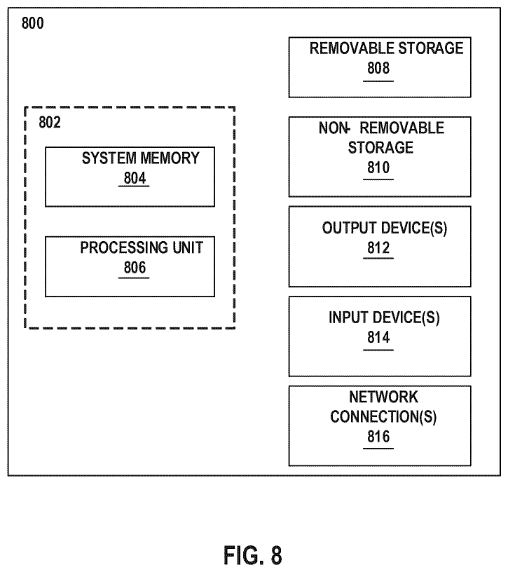

FIG. 1A is a flowchart of an example computer-implemented method 100 for reconstructing a 3D refractive index to generate a 3D image of a sample. FIG. 1B shows aspects of the computation design that can be incorporated into the proposed method 100. In some implementations, the method 100 can be performed by a processing circuitry (for example, but not limited to, an application-specific integrated circuit (ASIC), or a central processing unit (CPU)). In some examples, the processing circuitry may be electrically coupled to and/or in electronic communication with other circuitries of an example computing device, such as, but not limited to, the example computing device 800 described above in connection with FIG. 8. In some examples, embodiments may take the form of a computer program product on a non-transitory computer-readable storage medium storing computer-readable program instruction (e.g., computer software). Any suitable computer-readable storage medium may be utilized, including non-transitory hard disks, CD-ROMs, flash memory, optical storage devices, or magnetic storage devices. This disclosure contemplates that the example operations can be performed using one or more computing devices (e.g., at least the basic configuration illustrated in FIG. 8 by box 802). Conventional technologies are unable to provide independent generation of each illumination angle in a manner that optimizes power efficiency based on the density of the illumination angles as described herein.

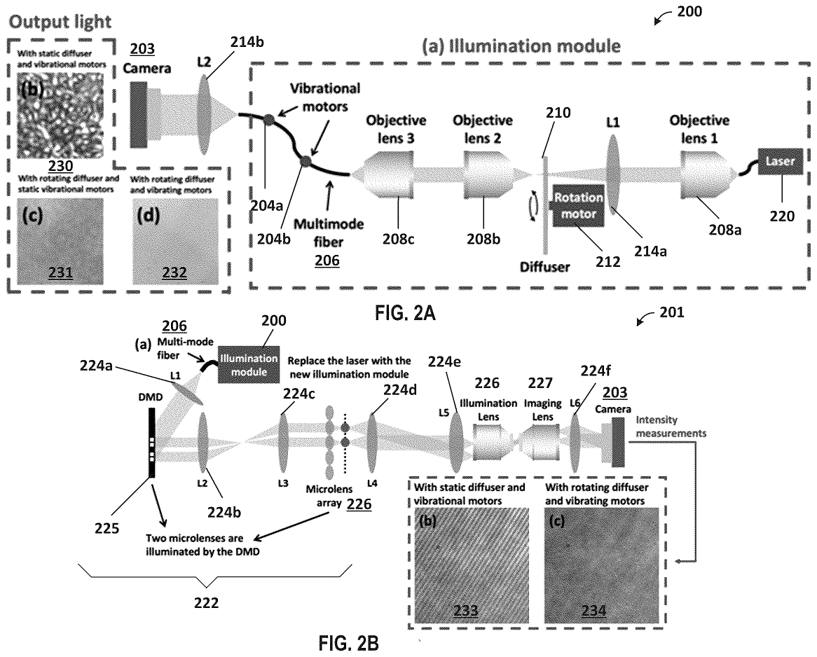

Referring to FIG. 1A, at step 110, the method 100 includes receiving a plurality of 2D images captured at a plurality of illumination angles or imaging configurations. For example the images can be captured using the light delivery component 200 and/or system 201 discussed in more detail below with reference to FIGS. 2A-2B. In some implementations, step 110 can include aligning a DMD to a microlens array (e.g., physically aligning the DMD to the microlens array) prior to capturing the plurality of images to ensure that the images are suitable or downstream operations.

Optionally, at step 120, the method 100 includes determining a 3D refractive index initial guess. In some implementation, the method 100 includes calibrating incident angles of the plane wave illumination beams using an angle-calibration operation.

At step 130, the method 100 includes determining, using a layer-by-layer decomposition operation and based, at least in part, on the determined 3D refractive index initial guess, one or more transmittance properties (e.g., propagation kernel and complex transmittance) as the light beam passes through the sample at each of the plurality of illumination angles or imaging configurations. In some examples, the one or more transmittance properties include at least a transmittance magnitude and phase shift.

At step 140, the method 100 includes simulating 2D acquisition images based on the determined one or more transmittance properties.

Optionally, at step 145, the method 100 includes implementing a 3D total-variation (TV) regularization operation in order to attenuate noise and/or poor conditioning.

Optionally, at step 147, the method 100 includes updating the 3D refractive index initial guess based on or using a gradient descent algorithm. This disclosure contemplates that step 147 can employ additional/alternative methods for updating the 3D refractive index initial guess including a diffusion model, an adversarial model, and/or machine learning model/algorithm.

At step 150, the method 100 includes reconstructing 3D refractive index to generate a 3D image of the sample by iteratively minimizing a difference between the simulated 2D images and the captured 2D images. In some implementations, step 150 includes reconstructing the 3D refractive index to generate the 3D image by iteratively applying a multi-slice beam propagation (MSBP) or MSBP forward model operation.

### Example System and Light Delivery Component

As noted above, embodiments of the present disclosure provide a light delivery component and system capable of illuminating a sample with multiple angled plane waves simultaneously in a manner that supports real-time ODT imaging at high acquisition speeds.

Referring now to FIG. 2A, an example light delivery component 200 in accordance with certain embodiments of the present disclosure is shown. As illustrated, the light delivery component 200 comprises a vibrating multimode fiber 206 operatively coupled to one or more vibrational motors (204a, 204b), one or more objective lens (208a, 208b, 208c), at least one rotating diffuser 210, a rotation motor 212, at least one focusing lens 214a, and a laser 220. The light delivery component 200 is configured to condition a light beam generated by the laser 220 to illuminate a sample with multiple angled plane waves simultaneously. In various embodiments, the at least one rotating diffuser 210 and vibrating multimode fiber 206 are used to reduce the coherence of the laser source. As illustrated, each element/component of the light delivery component 200 is positioned along an optical path leading from the laser 220 to an imaging component 203.

FIG. 2A further illustrates output light images 230, 231, 232 captured when the light delivery component 200 is used in various modes. The first image 230 shows output light from the light delivery component 200 when using a static diffuser and static vibrational motors 204a, 204b. The second image 231 shows output light from the light delivery component 200 when using at least one rotating diffuser 210 and static vibrational motors. The third image 232 shows output light from light delivery component 200 when using at least one rotating diffuser 210 and one or more vibrating motors 204a, 204b. As shown, the use of the at least one rotating diffuser 210 and one or more vibrational motors 204a, 204b measurably improves the quality of the output light and corresponding images.

In some implementations, the at least one rotating diffuser 210 is configured, in conjunction with the rotation motor 212, to scatter the light beam. Additionally, the at least one focusing lens 214a is configured to collect the scattered light beam and focus it into the multimode fiber 206. Then, the multimode fiber 206 is configured to scramble or further disperse the scattered/focused light beam using the one or more vibrational motors 204a, 204b. The conditioned light beam is then output to an imaging component 203 (e.g., camera) of a 3D imaging system (201) that is configured to capture a plurality of 2D images at each of the plurality of illumination angles or imaging configurations.

Referring now to FIG. 2B, an example 3D imaging system 201 (e.g., DMD-MLA optical diffraction tomography system) in accordance with certain embodiments of the present disclosure is shown. As illustrated, the system 201 includes a light delivery component 200 which may be similar or identical to the light delivery component 200 described in connection with FIG. 2A. The 3D imaging system 201 includes a fully-switchable angle scanning component 222 that is operatively coupled to the light delivery component 200 via the multi-mode fiber 206. Additionally, the 3D imaging system 201 includes a plurality of lenses (e.g., objective or focusing lenses) 224a, 224b, 224c, 224d, 224e, 224f, an illumination lens 226, and an imaging lens 227 operatively coupled to an imaging component 203. This disclosure contemplates that a micro-LED can be substituted with the DMD-MLA module described herein to achieve high speed angle scanning with angle multiplexing capabilities for ODT systems.

In the example shown in FIG. 2B, the fully-switchable angle scanning component 222 includes a DMD element 225 and microlens array 226. The DMD element 225 can include a plurality of micromirrors that are each configured to switch between an on-state and an off-state. In some implementations, in an on-state, a respective subset of the plurality of micromirrors is configured to generate a focal point on a corresponding location of the microlens array at one or more predetermined angles (e.g., between two and twenty predetermined angles). In some implementations, each respective subset of the plurality of micromirrors comprises a plurality of micromirror patches that each, in the on-state, generate a respective focal point on a single microlens of the microlens array 226. This disclosure contemplates that each micromirror path can the circular, oval, round, elliptical, or the like. In some embodiments, the illuminated sample is scanned by multiplexing the plurality of illumination angles by simultaneously switching through the plurality of micromirror patches. In some examples, each respective subset of the plurality of micromirrors is activated sequentially.

The fully-switchable angle scanning component 222 (e.g., DMD-MLA angle scanning module) realizes switchable sequential angle scanning for optical diffraction tomography. In this system, a partially coherent red laser (Thorlabs, S4FC660, λ₀=660 nm, Δλ=0.251 nm. Coherence length

$${L}_{c} = \frac{2 ln 2}{π} \frac{{λ}_{0}^{2}}{Δλ} = 0.77 mm )$$

is used as the illumination source. The inherent high power of laser provides high SNR, but the spatial coherence of the laser can be problematic when angles are multiplexed. When illuminating the sample with multiple angled plane waves simultaneously, sinusoidal interference fringes will be formed due to the phase difference between the plane waves. Since the proposed reconstruction model is based on iterative optimization, these interference patterns can corrupt the reconstruction when searching for 3D refractive index (RI) distribution. Therefore, in some implementations, the system is optimized by replacing the laser in the sequential scanning system with the light delivery component 200 described above in connection with FIG. 2A and FIG. 2B to reduce the spatial coherence of the illumination and eliminate the interference fringes when multiplexing various angles.

FIG. 2B further illustrates additional images (fourth image 233 and fifth image 234) captured when the system 201/light delivery component 200 are used in different modes. The fourth image 234 shows intensity measurements at the imaging plane of the imaging component 203 when the diffuser and the multimode fiber are static. The fifth image 234 intensity measurements at the imaging plane of the imaging component 203 with at least one rotating diffuser 210 and a vibrating multimode fiber 206. The fourth image 233 and fifth image 234 demonstrate that the proposed system reduces spatial coherence and eliminates interference when multiplexing various angles.

For the light delivery component 200 (e.g., illumination module), we use a similar setup as in [1] and two methods are combined to create sufficient reduction of the spatial coherence of the laser 220: (1) use a rotating ground glass diffuser 210 in the optical path [2], (2) couple the light into a multimode fiber and vibrate the fiber [3]. As shown in FIG. 2A, the fiber coupled red laser 220 is collimated using objective lens 1 208a (Newport, Microscope Objective Lens, 20x, 0.40 NA, 9.0 mm Focal Length), and we use a lens L1 214a (Thorlabs, AC508-200-A-ML) to create a Fourier plane. The diffuser 210 (Edmund Optics, 100 mm Diameter 120. Grit Ground Glass Diffuser) is attached to a rotation motor 212 (XD-3420 24V DC Electric Motor, Electric Gear Motor, 7000 RPM DC 24V High Speed Permanent Magnet DC Motor (24V 7000 RPM)) and is placed near the Fourier plane. The light will be scattered by the diffuser 210, and when the diffuser 210 is rotating, spatially varying phase delays are created at each component of the scattered light, which can reduce the coherence of the averaged light. The scattered light is collected by objective lens 2 208b (CFI Plan Apochromat Lambda D 2X 0.1NA) and is focused into a multimode fiber 206 (M15L05-Ø105 μm, 0.22 NA, SMA-SMA Fiber Patch Cable, Low OH, 5 m Long) by objective lens 3 208c (CFI Plan Apochromat Lambda D 4X 0.2NA). The light can be scrambled by the multimode fiber 206, which provides the further reduction of the coherence since each mode in the fiber 206 is incoherent with the other. Two vibrational motors 204a, 204b are attached to the multimode fiber 206 and the vibration can provide time-varying mode coupling and speckle suppression. The output light of this light delivery component 200 (e.g., illumination module) is collected by a lens L2 214b (Thorlabs, AC508-100-A-ML) and then imaged onto a light delivery component 200 (e.g., camera). As noted above, FIG. 2A (images 230, 231, 232) show the output light under different conditions. When the diffuser 210 and the vibrational motor(s) 204a, 204b are both static, high contrast speckle patterns caused by the diffuser and the fiber can be observed in the output light as shown in the first image 230. When the diffuser 210 is rotating, the speckles are partially averaged and become lower contrast as shown in the second image 231. By simultaneously rotating the diffuser 210 and vibrating the multimode fiber 206, the speckles can be all averaged out as shown in the third image 232. This output light can provide uniform illumination for the imaging system 201.

We then validate the reduced coherence of the illumination by connecting it to the 3D imaging system 201 (e.g., DMD-MLA imaging system). As shown in FIG. 2B, the light delivery component 200 replaces a standard laser. Corresponding binary pattern is put on the DMD element 225 to illuminate two microlenses 226 and result in one on-axis and one off-axis plane wave illuminating the sample plane. We first keep the diffuser 210 and the vibrational motors 204a, 204b static, and the intensity measurement at the imaging plane is as depicted in the fourth image 233. Sinusoidal interference fringes can be observed which indicates the coherence of the illumination. After turning on the motors 204a, 204b, the fringes are averaged out and the field of view is uniformly illuminated as shown in the fifth image 234. Therefore, by using the proposed light delivery component 200, the 3D imaging system 201 (e.g., DMD-MLA system) has the capability to illuminate the sample with multiple plane waves without creating interference fringes.

### Example Optical System

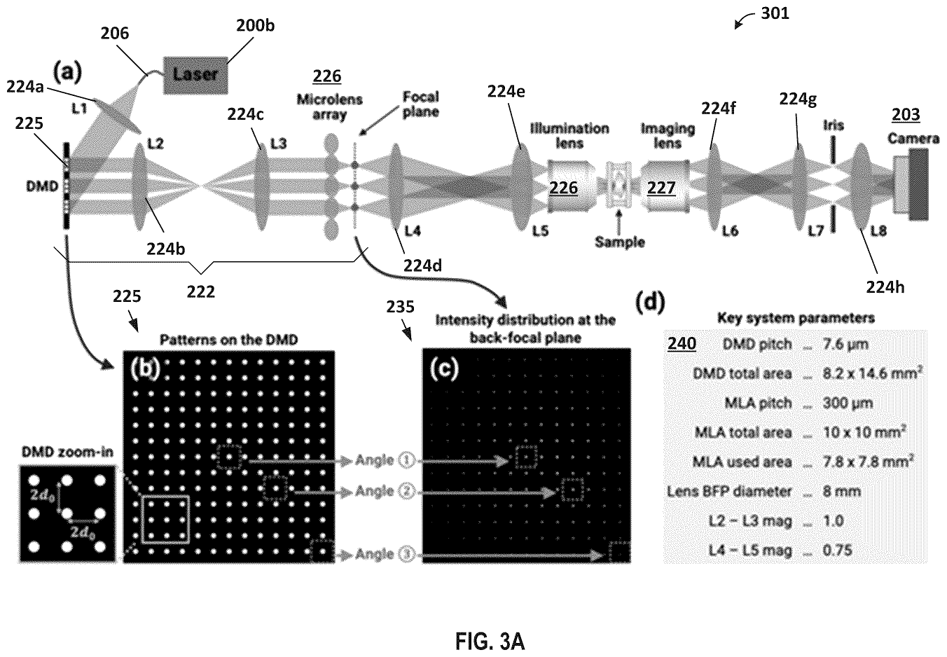

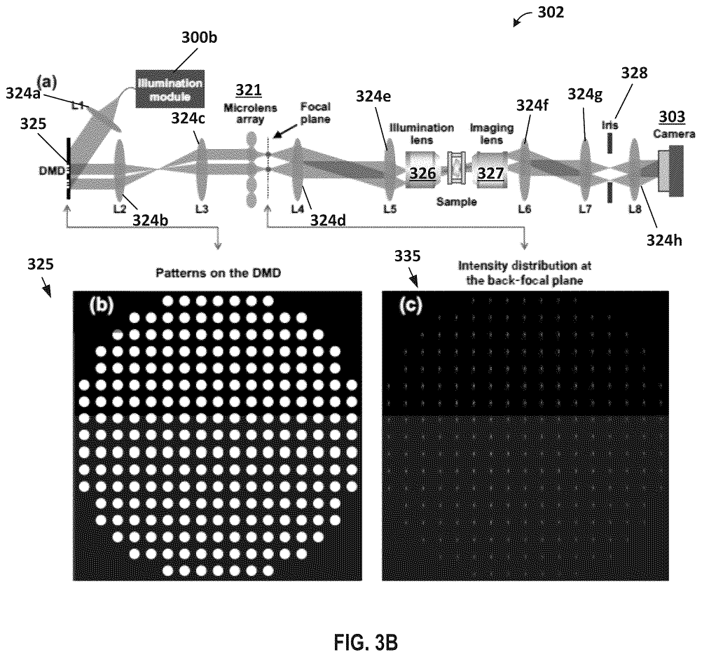

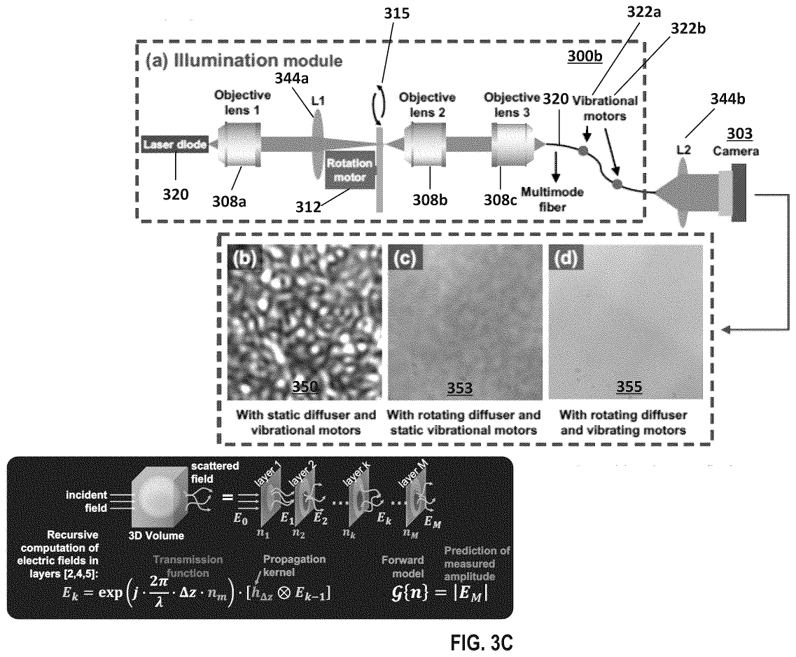

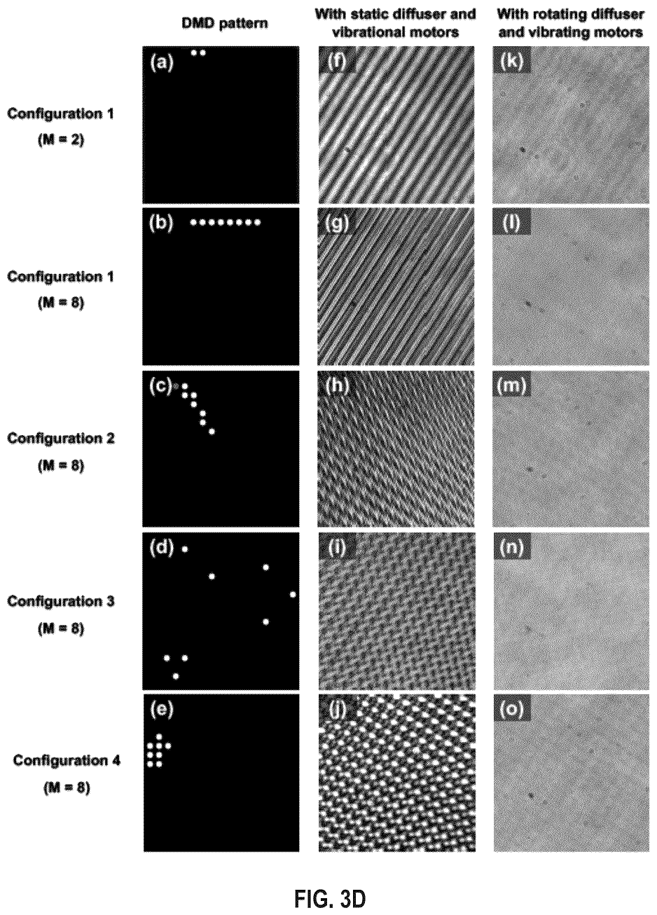

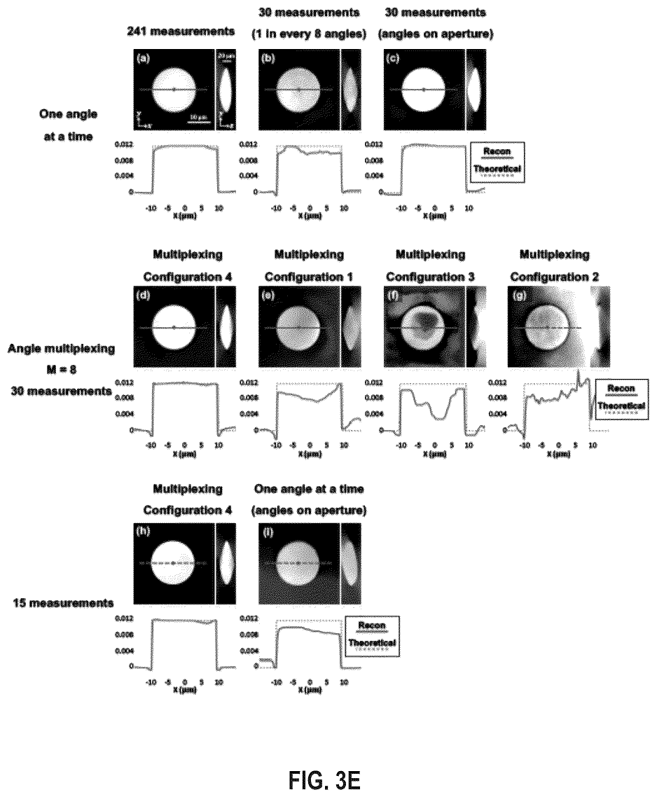

FIG. 3A shows an optical schematic for an example non-interferometric ODT system 301 in accordance with certain embodiments described herein. Similar to the 3D imaging system 201 described in connection with FIG. 2B, the system 301 includes a laser 200b, a fully-switchable angle scanning component 222 that is operatively coupled to the laser 200b via a multi-mode fiber 206. Additionally, the system 301 includes a plurality of lenses, for example, objective lenses/focusing lenses (224a, 224b, 224c, 224d, 224e, 224f, 224g, 224h), an illumination lens 226, an imaging lens 227, and an imaging component 203. In some implementations, the system 301 includes a light delivery component 200 similar or identical to the light delivery component 200 described above in connection with FIG. 2A instead of a laser 200b.

The surface plane of a digital-micromirror-device (DMD) (Vialux, V-6501) element 225 is imaged onto a microlens-array 226 (MLA, Edmund Optics, 10×10 mm, 300 um Pitch, 2° Divergence, VIS-NIR Coated). For an illumination source, a partially coherent red laser (200b) was used (Thorlabs, S4FC660, λ₀=660 nm, Δλ=0.251 nm.Coherence length

$${L}_{c} = \frac{2 ln 2}{π} \frac{{λ}_{0}^{2}}{Δλ} = 0.77 mm [ 36 ] ) .$$

A partially coherent laser (200b) was used because it combines the benefits of high-power in standard lasers with the benefits of sufficient incoherence, so as to minimize coherent artifacts caused by system imperfections or vibrations. Additionally, the laser's narrow bandwidth ensures that we avoid spectral dispersion effects typically seen when a DMD 225 is illuminated with broadband multispectral light [37, 38].

The laser light is spatially filtered by a single-mode fiber (Thorlabs, P2-630A-PCSMA-1) and collimated by L1 (224a) (Nikon, CFI Plan Apochromat Lambda D 4X, NA 0.2) to create a plane wave that fully illuminates the DMD 225. DMDs are composed of millions of micromirrors that quickly switch between “on” and “off” states, enabling binary pattern display speeds of tens of kilohertz. We align the DMD 225 so that light reflected by the “on” state is parallel to the optical axis of the system 301. The DMD 225 is then imaged onto the plane of the MLA 226 by a unity-magnification 4f system (L2, L3: Thorlabs, AC508-200-A-ML (224b, 224c)). When all DMD micromirrors are turned to the “on” state, the DMD 225 reflects a plane wave onto the MLA 226, which then generates a grid of focal spots. A second 4f system, with a magnification factor of 0.75 (L4: Edmund Optics 75 mm diameter Achromatic Lens, f=200 mm, and L5: Edmund Optics 75 mm diameter Achromatic Lens, f=150 mm (224d, 224e)), is used to image these focal spots to the back-focal-plane (BFP) of the illumination objective lens (Edmund Optics, 20X Mitutoyo Plan Apo NIR Infinity Corrected Objective, NA 0.4). The illumination lens transforms each spot in its BFP into a plane-wave that illuminates the sample volume at a specific angle. This constitutes the ODT system's 301 switchable angle-scanning module (222).

The imaging objective lens 227 is identical to the illumination lens 226 (Edmund Optics, 20X Mitutoyo Plan Apo NIR Infinity Corrected Objective, NA 0.4). After the imaging objective, a third 4f system (L7, f=200 mm and L8, f=150 mm) relays the sample image to the camera 203. An adjustable iris is placed at the Fourier plane of this 4f system. We close down the diameter of this iris to reduce the numerical-aperture (NA) of the imaging system to 0.37, which was empirically found to minimize aberrations while maintaining high image quality. This NA corresponds to lateral and axial resolutions of λ/2NA=0.89 μm and 2λ/NA²=9.29 μm [39], respectively. The image measurements are acquired by a monochrome camera 203 (Touptek, 13CMOC01500KM) with a frame-rate of 125 Hz.

Importantly, the magnifications of the first two 4f systems (L2-L3 (224b, 224c) and L4-L5 (224d, 224e)) determine the performance of the ODT system's switchable angle-scanning module 222. Specifically, these magnifications can be chosen to optimize the tradeoff between the density of illumination angles and the power delivered per illumination angle. The L2-L3 4f system first relays an image of the DMD 225 onto the MLA 226. The magnification of this first 4f system determines 1) the number of individual microlenses in the MLA 226 that are illuminated, which in turn affects both the number/density of illumination angles and the maximum illumination angle the ODT system 301 can support; and 2) how many DMD micromirrors direct light into a single microlens. This in turn affects the light power in each angled illumination beam. The more DMD micromirrors that fit within each microlens, the greater the power per illumination angle.

The L4-L5 (224d, 224e) 4f system images the grid of focal spots generated by the MLA 226 onto the BFP of the illumination lens 226. The magnification factor of this second 4f system determines 1) the size of the focal-spot grid at the BFP of the illumination lens 226. The larger the grid that spans across the BFP aperture, the greater the angle of the most oblique illumination beam, up to the maximum angle supported by the illumination lens's (227) numerical aperture; and 2) the size of each focal spot at the BFP of the illumination lens, which determines the width of the collimated beams that exit the illumination lens. This in turn determines the imaging field-of-view (FOV) of the ODT system 301.

When designing the ODT system 301 shown in FIG. 3A the magnifications of the 4f systems were selected so that a ˜26×26 grid of focal spots generated by the MLA would be demagnified to fully cover the illumination lens' (227) back focal plane (BFP). Since this illumination lens 227 had a native NA of 0.4 in air, our system design allowed approximately 676 (26×26) distinct illumination angles, with a maximum angle of θ=sin⁻¹ (NA)≈24 degrees. In FIG. 3, we summarize key system parameters 240 to enable this. It's important to note that if different illumination lenses 226, MLAs 226, or DMDs 225 were used, the sizes of the lens BFP, microlens pitch, and DMD micromirror pitch would differ. In such cases, the magnifications of the 4f systems would need to be adjusted accordingly to achieve a comparable number of illumination beams spanning the same angular range.

Lastly, we note that by switching specific patches of DMD micromirrors to their ‘on’ state, individual microlenses can be activated to generate focal spots. The calibration process to map patches of DMD micromirrors to each individual microlens (described in the following section) maps circular micromirror patches on the DMD 225 to individual microlenses in the MLA 226 as shown in FIG. 3. By sequentially switching through these circular DMI) micromirror patches, we can create an illumination beam that angularly scans through the sample at the DMD's inherent 10.3 kHz switching speed, i.e., no time-averaging is required. Furthermore, simultaneously switching on multiple micromirror patches would result in multiplexing various illumination angles, which could in principle further increase the effective acquisition speed.

### DMD and MLA Alignment Calibration

To align the DMD 225 to the MLA 226, the DMD plane is positioned so that when a patch of center DMD micromirrors are switched on, the reflected light travels along the optical axis. At the image plane conjugated to the DMD 225 via the first 4f system, the MLA 226 is positioned such that the center microlens is also aligned with the optical axis.

To find the circular patches of micromirrors on the DMD plane that correspond to each individual microlens, we first compute the diameter of the circular patches and the distance between adjacent patches. Based on factory specifications, we define a=7.6 μm to denote the pitch of an individual DMD micromirror, and b=300 μm to denote the diameter of each microlens within the MLA 226. Since each circular patch of DMD micromirrors is imaged onto the MLA 226 with a unity-magnification 4f system, each circular micromirror patch will need theoretically a diameter of d₀=b/a=39 micromirrors to fill out a complete microlens. In practice, however, individual microlenses exhibit aberrations which degrade the quality of the focal spot, resulting in non-planar illumination waves. We empirically found that using a circular micromirror patch with diameter d=26 micromirrors balances between microlens aberrations and light power. Furthermore, we empirically found that activating only half of the available microlenses in each direction (i.e., a quarter of the total microlenses) was sufficient to achieve high-quality RI reconstructions. Thus, adjacent micromirrors did not have to be activated, and the gap between each circular micromirror patch on the DMD plane was 2d₀. After calibration, activating a binary circle-grid pattern on the DMD 225 (see FIG. 3) resulted in a grid of focal spots 235 which were eventually imaged to the BFP of the illumination lens 227. The dashed green boxes in FIG. 3A (e.g., shown on DMD 225 and grid of focal spots 235) indicate the focal spots resulting from activating specific circular micromirror patches on the DMD 225.

### Example DMD-MLA Angle Scanning System

FIG. 3B shows an example non-interferometric imaging system configured to enable angle multiplexed measurements. FIG. 3B depicts an example optical imaging system 302 with a DMD-MLA angle scanning module.

As illustrated, a DMD 325 ((Vialux, V-6501) is imaged onto an MLA 321 (Focuslight, ZLA000481) by a first 4f system (324b, 324c) (L2: Thorlabs, AC508-150-A-ML, L3: Thorlabs, AC508-200-A-ML). DMD 325 is a pixel addressable device and every pixel has “on” and “off” states. When all the pixels are activated to “on” state, the whole MLA plane will be illuminated and formulate a grid of focal spots. A second 4f system (324d, 324e, 324f), (L4: Edmund Optics 75 mm diameter Achromatic Lens, f=150 mm, L5: Edmund Optics 75 mm diameter Achromatic Lens, f=100 mm), images the focal spots onto the back-focal-plane (BFP) of the illumination lens 326 (Olympus, UPLFLN40XP). The illumination lens 326 transforms each spot in its BFP into a plane-wave that illuminates the sample volume at a specific angle. This constitutes the ODT system's switchable angle-scanning module. In the example shown in FIG. 3B, the imaging objective lens 327 is identical to the illumination lens 326. After the imaging objective, a third 4f system (324f, 324g, 324h) (L6: Thorlabs, AC508-100-A-ML, L7: Thorlabs, AC508-100-A-ML, L8: Thorlabs, AC508-100-A-ML) relays the sample image to the camera 303. An adjustable iris 328 is placed at the Fourier plane of this 4f system (324f, 324g, 324h). We close down the diameter of this iris 328 to reduce the numerical-aperture (NA) of the imaging system 302 to around 0.67, which was empirically found to minimize aberrations while maintaining high image quality. This NA corresponds to lateral and axial resolutions of λ/2NA=0.476 μm and 2λ/NA²=2.84 μm, respectively. The intensity measurements are acquired by a monochrome camera 303 (Touptek, IUAM820000A).

To align the DMD 325 to the MLA 321, the DMD plane is positioned so that when a patch of center DMD micromirrors are switched on, the reflected light travels along the optical axis. At the image plane conjugated to the DMD 325 via the first 4f system (324b, 324c), the MLA 321 is positioned such that the center microlens is also aligned with the optical axis. To find the circular patches of micromirrors on the DMD plane that correspond to each individual microlens, we first compute the diameter of the circular patches and the distance between adjacent patches. Based on factory specifications, we define a=7.6 μm to denote the pitch of an individual DMD micromirror, and b=500 μm to denote the diameter of each microlens within the MLA 321. Since each circular patch of DMD micromirrors is imaged onto the MLA 321 with a magnification of 1.33, each circular micromirror patch will need theoretically a diameter of

$${d}_{0} = \frac{b}{1.33 a} = 49$$

micromirrors to fill out a complete microlens. In practice, however, individual microlenses exhibit aberrations which degrade the quality of the focal spot, resulting in non-planar illumination waves. We empirically found that using a circular micromirror patch with diameter d=40 micromirrors balances between microlens aberrations and light power. After calibration, activating a binary circle-grid pattern on the DMD (first image 325 shows DMD pattern when all microlenses are activated where each circular pattern controls one microlens) resulted in a grid of focal spots (second image 335 shows focal points generated at the back-focal plane when all microlenses are activated) which were eventually imaged to the BFP of the illumination lens 326.
Illumination System with Tunable Coherence

FIG. 3C shows an illumination module 300b for the DMD-MLA system with tunable coherence, as demonstrated in the series of images 350, 353, 355 which show collimated output intensities from the multimode fiber. The first image 350 shows intensity with static diffuser and vibrational motors, the second image 353 shows intensity with rotating diffuser and static vibrational motors, and the third image 355 shows intensity with rotating diffuser and vibrating motors.

In the DMD-MLA system, a laser is used for the illumination source. Since the proposed forward model is based on coherent propagation, the high coherence of the illumination reduces the model miss match. However, when multiplexing different illumination angles, sinusoidal interference fringes will be formed due to the phase difference between the plane waves, as shown in the third image 355 in FIG. 3B. Since our iterative reconstruction relies on the intensity contrast, these interference patterns can corrupt the reconstruction when searching for 3D refractive index (RI) distribution. Therefore, we use the illumination module 300b in FIG. 3B to reduce the spatial coherence of the illumination and eliminate the interference fringes when multiplexing various angles. Two methods are combined to create sufficient reduction of the spatial coherence of the laser: (1) use a rotating ground glass diffuser in the optical path, (2) couple the light into a multimode fiber and vibrate the fiber. As shown in FIG. 3B, the fiber coupled red laser is collimated using objective lens 1 308a (Newport, Microscope Objective Lens, 20x, 0.40 NA, 9.0 mm Focal Length), and we use a lens L1 344a (Thorlabs, AC508-200-A-ML) to create a Fourier plane. The diffuser 315 (Edmund Optics, 100 mm Diameter 120. Grit Ground Glass Diffuser) is attached to a rotation motor 312 (XD-3420 24V DC Electric Motor, Electric Gear Motor, 7000 RPM DC 24V High Speed Permanent Magnet DC Motor (24V 7000 RPM)) and is placed near the Fourier plane. The light will be scattered by the diffuser 315, and when the diffuser is rotating, spatially varying phase delays are created at each component of the scattered light, which can reduce the coherence of the averaged light. The scattered light is collected by objective lens 2 308b (CFI Plan Apochromat Lambda D 2X 0.1NA) and is focused into a multimode fiber 320 (M15L05-Ø105 μm, 0.22 NA, SMA-SMA Fiber Patch Cable, Low OH, 5 m Long) by objective lens 3 308c (CFI Plan Apochromat Lambda D 4X 0.2NA). The light can be scrambled by the multimode fiber 320, which provides the further reduction of the coherence since each mode in the fiber 320 is incoherent with the other. Two vibrational motors 322a, 322b are attached to the multimode fiber 320 and the vibration can provide time-varying mode coupling and speckle suppression. The output light of this illumination module 300b is collected by a lens L2 344b (Thorlabs, AC508-100-A-ML) and then imaged onto a camera 303. The series of images 350, 353, 355 show the output light under different conditions. When the diffuser 315 and the vibrational motor(s) 322a, 322b are both static, high contrast speckle patterns caused by the diffuser 315 and the fiber 320 can be observed in the first image 350. When the diffuser 315 is rotating, the speckles are partially averaged and become lower contrast as shown in the second image 353. By simultaneously rotating the diffuser 315 and vibrating the multimode fiber 320, the speckles can be all averaged out as shown in the third image 355. This output light can provide uniform illumination for the imaging system.

We then validate the reduced coherence of the illumination by connecting it to the DMD-MLA imaging system. As shown in FIG. 3C, panels a-e, different DMD patterns are used to generate multiplexed plane-wave illuminations at the imaging plane, with two or eight angled illuminations respectively. We first keep both the diffuser and the vibrational motors static, and the intensity measurement are shown as FIG. 3C, panels f-j. Interference fringes with high contrast in all measurements indicate the coherence of the illumination. After turning on the motors, the fringes are averaged out and the field of view can be illuminated nearly uniformly as shown in FIG. 3C, panels k-o. FIG. 3C demonstrates that the proposed illumination module allows the DMD-MLA system to illuminate the sample with multiple plane waves without creating interference fringes.

### Multiplexing Configuration Design

FIG. 3D illustrates different illumination configurations with tunable coherent source. Panels (a-e) are DMD patterns for different illumination configurations. Panel (a) uses two illumination angles on the same row. Panel (b) uses eight illumination angles on the same row. Panel (c) uses eight illumination angles with similar angular locations. Panel (d) uses eight illumination angles at random locations. Panel (e) uses eight illumination angles that are close in the k space. Panels (f-j) show the corresponding intensity measurements when the diffuser and the vibrational motor are both static. Panels (k-o) show the corresponding intensity measurements when the diffuser is rotating and the motor is vibrating.

When illuminating the sample with multiple angles simultaneously, using different combinations of angles could affect the quality of reconstruction. Therefore, we designed four multiplexing configurations. In FIG. 3D, panels (b-e), we use the same multiplexing factor (M=8), and each configuration is illustrated by shown one frame of the DMD pattern, which corresponds to the angle distribution on the Fourier plane. Configuration 1 is shown in FIG. 3D, panel (b), angles on the same row are grouped together. Configuration 2 is shown in FIG. 3D, panel (c), angles with similar angular position are grouped together. Configuration 3 is shown in FIG. 3D, panel (d), angles are grouped together randomly. Configuration 4 is shown in FIG. 3D, panel (e), angles that are close on the k space are grouped together.

### Quantitative Verification

FIG. 3E illustrates polymethyl methacrylate (PMMA) microsphere reconstruction and corresponding line profile with different illumination configurations. Panels (a-c) show sequentially scanning through different angles. Panel (a) uses all 241 angles. Panel (b) uses one angles in every eight angles, 30 measurements in total. Panel (c) uses angles on the aperture, 30 measurements in total. Panels (d-g) show multiplexing eight angles for each measurement, 30 measurements in total. Panel (d) uses multiplexing configuration 4. Panel (e) uses multiplexing configuration 1. Panel (f) uses multiplexing configuration 3. Panel (g) uses multiplexing configuration 2. Panels (h,i) compare sequential scanning and angle multiplexing with both 15 measurements. Panel (h) uses multiplexing configuration 4 with the 15 illumination groups near aperture. Panel (i) uses 15 angles on the aperture.

We firstly explore the quantitative accuracy on 3D RI imaging with multiplexing strategies. Two 20 μm PMMA microspheres are imaged under the DMD-MLA system with different angle scanning strategies and the 3D RI is reconstructed. The PMMA beads were immersed in index matching oil (Cargille Standard Series Liquids). At illumination wavelength λ=638 nm, the immersion oil RI is n₀=1.47, and the PMMA sphere RI is nPMMA=1.4887. Given the imaging system has the NA of 0.68, the ideal sphere is filtered with the optical transfer function (OTF), which results in a theoretical RI difference AR=0.0116. The lateral and axial cross-sections of the reconstructions are shown in FIG. 3E. The line profiles are acquired at the center of the reconstructed beads and compared with theoretical RI values for quantitative analysis.

FIG. 3E, panels (a-c) show reconstructions using one illumination at a time, but different angles were selected. In FIG. 3E, all 241 angles are scanned sequentially. An accurate and uniform reconstruction can be obtained. In FIG. 3E, panel (b), in every eight angles, one angle is selected and these 30 angles are scanned sequentially. The degradation in the reconstruction is very obvious. The RI values become inaccurate and many artifacts appear within the bead. Then, also using 30 angles, we selected angles on the edge of the system's aperture. Previous works have shown that for weakly-scattering samples, these angles matter more in reconstructions. And the results in FIG. 3E, panel (c) show that with fewer measurements, when the illuminations are the aperture, bead reconstruction with high quality can still be obtained, with slightly elongation in the axial direction.

FIG. 3E, panels (d-g) compare different angle multiplexing configurations with the same multiplexing factor (M=8), which corresponds to 30 measurements to cover the 241 angles. When using multiplexing configuration 4, which groups angles with similar k space positions, the reconstructions remain good quantitative accuracy with slightly degradation in the axial direction. However, with configurations 1, 3 and 2, the reconstructions become very poor with large artifacts. Therefore, we can see that with a reduced number of measurements, using configuration 4 to multiplex angles gives the best reconstruction results.

Previous results have shown that there are two ways to effectively reduce the number of measurements, and in the meantime preserve a reasonable reconstruction quality. (1) Only using angles on aperture with sequential measurements. (2) Multiplexing angles with configuration 4. We then further reduce the number of measurements from 30 to 15, and compare reconstruction results with sequential multiplexed measurements. When using multiplexing strategy, we keep configuration 4, and selected 15 angle groups near the edge of the aperture. And the reconstruction result is shown in FIG. 3E, panel (h). For sequential angle scanning, 15 angles on the edge of the aperture are used, and the reconstruction result is shown in FIG. 3E, panel (i). Although both results show more degradations, with multiplexing strategy, the bead reconstruction has accurate RI values and relative good morphology, while the one with sequential scanning, the quantitative accuracy is very poor with large artifacts in the axial direction.

### Data Acquisition

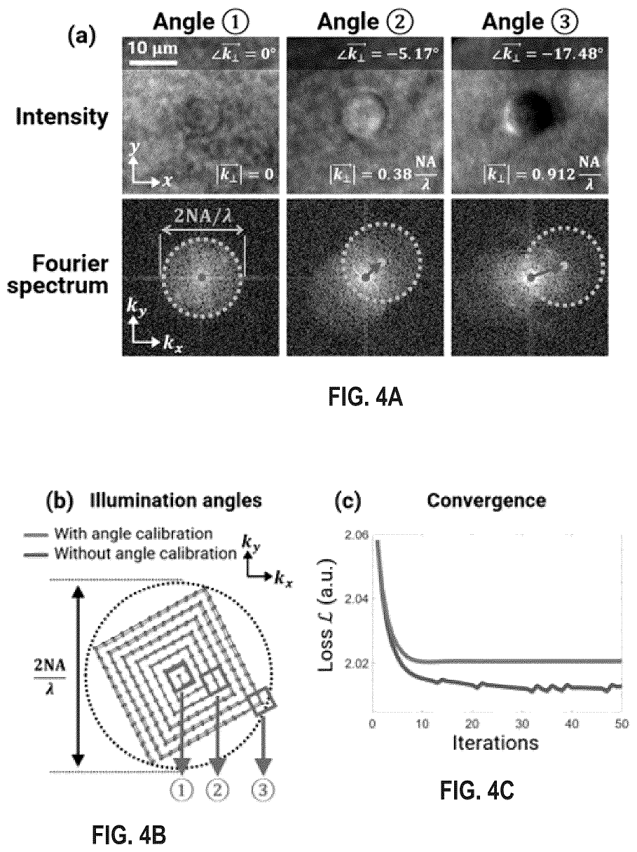

FIG. 4A shows intensity measurements of a 10 μm polystyrene microsphere and corresponding Fourier spectra at different illumination angles 1, 2, and 3. FIG. 4B depicts the trajectory of illumination angles before and after angle calibration, measured by the center position in Fourier space of the yellow dashed circles in FIG. 4A. FIG. 4C is a graph illustrating that when using multi-slice beam-propagation, the calibrated illumination trajectory results in a smoothly converging cost function, while the uncalibrated angles result in a more unstable cost curve, indicating instabilities in the convergence process.

We sequentially activated every other microlens in a 26×26 array of microlenses in the MLA, generating a total of 13×13=169 separate angles of illumination. The acquisition speed is currently limited by the 125 Hz frame-rate of our camera. FIG. 4A shows the raw intensity images and the associated Fourier transforms resulting from illuminating the sample with the angled beams corresponding to the focal spots 235 indicated in FIG. 3. In FIGS. 4A-C, we specify illumination angles in terms of the lateral component of the illumination wave-vector within the sample volume, \vec{k}_{⊥}=(kₓ, k_{y}). Specifically, angle \textcircled{1} demonstrates on-axis illumination (i.e., |\vec{k}_{⊥}|=0), while angles \textcircled{2} and \textcircled{3} denote off-axis illumination. Angle \textcircled{3} corresponds to an illumination angle from the edge of the system NA (i.e., |\vec{k}_{⊥}≈NA/A).

High fidelity RI reconstruction requires precise information about the illumination angle. Based on the factory-specified positions of microlenses within the MLA, initial guesses were made for each illumination angle. These initial guesses constitute the uncalibrated estimates of each illumination angle. Due to misalignment or magnification errors in the construction of an ODT system (e.g., system 301), these initial uncalibrated angle estimates may be slightly inaccurate. However, even slight inaccuracies in the estimates of illumination angle have been reported to significantly degrade image quality when reconstructed by phase-retrieval methods [40-43]. Thus, to correct for these inaccuracies, the initial uncalibrated estimates are used to then initiate an angle-calibration algorithm that detects the center position of one of the two circles in a raw measurement's Fourier transform when imaging a weak-scattering sample. This center position constitutes the calibrated estimate of the illumination angle. FIG. 4B compares the calibrated (red) and uncalibrated (blue) estimates of the illumination angles, and slight deviations are observed. From FIG. 4C, we observed that calibrating for these slight deviations in illumination angle stabilizes the convergence of our iterative multi-slice beam propagation inverse-scattering method (described below).

### Reconstruction of 3D Refractive Index

Several inverse-scattering reconstruction methods based on angle scanning are available to reconstruct an object's 3D RI from non-interferometric measurements [18, 19, 22, 35, 44]. Here, we showcase our imaging system's performance using the intensity diffraction tomography (IDT) and the multi-slice beam propagation (MSBP) frameworks, which both reconstruct a sample's 3D RI from non-interferometric angular scattering measurements. Both IDT and MSBP are associated with open-source GitHub code bases, which were used to generate the results shown in later sections. We briefly review IDT and MSBP below.

### Intensity Diffraction Tomography (IDT)

The major advantage of IDT is its capability to rapidly reconstruct a sample's 3D RI [18, 22]. IDT operates under the assumption that the sample satisfies the first-Born weak-scattering approximation. If this condition is satisfied, IDT derives 2D transfer functions for phase and amplitude imaging on a layer-by-layer basis, per illumination angle. Below, we present the expressions for these transfer functions, adapted from Li et al. [22]:

$${{H}_{P} ( u )}_{m}^{( ℓ )} = \frac{i {k}_{0}^{2} Δ z}{2} ( P ( u - {ρ}^{( ℓ )} ) \frac{exp ( - i [ η ( u - {ρ}^{( ℓ )} ) - η ( {ρ}^{( ℓ )} ) ] z )}{η ( u - {ρ}^{( ℓ )} )} \qquad ( {1}^{″} )$$

$${H}_{A} {( u )}_{m}^{( ℓ )} = - \frac{{k}_{0}^{2} Δ z}{2} ( P ( u - {ρ}^{( ℓ )} ) \frac{exp ( - i [ η ( u - {ρ}^{( ℓ )} ) - η ( {ρ}^{( ℓ )} ) ] z )}{η ( u - {ρ}^{( ℓ )} )} \qquad ( {2}^{″} )$$

In this formulation, the sample is modelled by a layer-by-layer decomposition, where the spacing between subsequent layers is Δz, and zΔmΔz denotes the axial location of the m-th layer. λ and k₀=2π/λ are the illumination wavelength and wavenumber, respectively, while u and

$$η ( u ) = \sqrt{{k}_{0}^{2} - {\vert u \vert}^{2}}$$

denote the 2D lateral and 1D axial components of 3D spatial frequency vectors, respectively.

$${{H}_{P} ( u )}_{m}^{( ℓ )} and {{H}_{A} ( u )}_{m}^{( ℓ )}$$

in Eqs. (1″) and (2″) represent the phase and absorption transfer functions, respectively, for the m-th sample layer when the sample is being illuminated by the [symbol] -th illumination angle. Lastly, P denotes the pupil function of the system, while [symbol] and

$$η ( {ρ}^{( ℓ )} ) = \sqrt{{k}_{0}^{2} - {\vert {ρ}^{( ℓ )} \vert}^{2}}$$

denote the lateral and axial component of the [symbol] -th illumination beam's wave-vector.

Reconstructing the sample's 3D RI from the transfer functions shown above follows a Tikhonov regularized deconvolution process. Notably, because the phase and absorption transfer functions from Eqs. (1″) and (2″) are defined independently for each sample layer, deconvolution at each layer is undertaken independently from every other layer. This key advantage arises due to IDT utilizing the first-Born approximation to simplify the scattering process. Following this deconvolution, the real (AERe) and imaginary (AcIm) component of the m-th layer of the sample's 3D permittivity contrast can be shown to be:

$${( Δ {ε}_{Re} )}_{m} ( r ) = {ℱ}^{- 1} \{ \frac{1}{A} ( [ {\sum }_{ℓ = 1}^{L} {\vert {{H}_{A} ( u )}_{m}^{( ℓ )} \vert}^{2} + β ] \cdot [ {\sum }_{ℓ = 1}^{L} ( {{H}_{P}^{*} ( u )}_{m}^{( ℓ )} \cdot {\tilde{g}}^{( ℓ )} ) ] \qquad ( {3}^{″} )$$

$${( Δ {ε}_{Im} )}_{m} ( r ) = {ℱ}^{- 1} \{ \frac{1}{A} ( [ {\sum }_{ℓ = 1}^{L} {\vert {{H}_{P} ( u )}_{m}^{( ℓ )} \vert}^{2} + α ] \cdot ⌈ {\sum }_{ℓ = 1}^{L} ( {{H}_{A}^{*} ( u )}_{m}^{( ℓ )} \cdot {\tilde{g}}^{( ℓ )} ) ⌉ \qquad ( {4}^{″} )$$

Here r is the lateral position vector inverse Fourier transformed from u. The operator symbol [symbol] {.} denotes the 2D inverse Fourier transform, and [symbol] denotes the Fourier transform of the [symbol] -th angular scattering measurement after background subtraction. In Eqs. (3″) and (4′), L denotes the total number of angular scattering measurements that were taken (e.g., 1≤ [symbol] L), while a and B are regularization parameters.

$$A = [ {\sum }_{ℓ = 1}^{L} {\vert {{H}_{P} ( u )}_{m}^{( ℓ )} \vert}^{2} + α ] \cdot [ {\sum }_{ℓ = 1}^{L} {\vert {{H}_{A} ( u )}_{m}^{( ℓ )} \vert}^{2} + β ] - [ {\sum }_{ℓ = 1}^{L} ( {{H}_{P} ( u )}_{m}^{( ℓ )} \cdot {{H}_{A}^{*} ( u )}_{m}^{( ℓ )} ) ] \cdot [ {\sum }_{ℓ = 1}^{L} ( {{H}_{P}^{*} ( u )}_{m}^{( ℓ )} \cdot {{H}_{A} ( u )}_{m}^{( ℓ )} ) ]$$

is a normalization term. After calculating the sample's 3D permittivity, the sample's 3D refractive index can be directly computed via a simple square root operation [47]. In this work, only the real part of the refractive index is considered since the sample is non-absorptive.

### Multi-Slice Beam Propagation (MSBP)

Similar to IDT, MSBP decomposes a 3D sample into a sequence of thin 2D layers. However, while IDT uses the first-Born approximation to treat light scattering at each sample layer independently from every other layer, MSBP accumulates the scattering effects as light propagates layer by layer through the sample. This approach allows MSBP to account for a moderate amount of multiple scattering by describing the natural evolution of a wave as it propagates through the 3D sample [35, 48]. Below, we present the mathematical framework for MSBP in the case of non-interferometric detection, adapted from Chowdhury et al. [35].

Following the IDT approach, MSBP decomposes a 3D sample into layers, with each layer spaced by a distance Δz from the next. Each layer acts as a 2D phase-mask that modulates the field incident to it, which itself had propagated a distance Δz from the previous layer:

$${y}_{m} ( r ) = {t}_{m} ( r ) \cdot [ {h}_{Δ z} ( r ) ⊗ {y}_{m - 1} ( r ) ] \qquad ( {5}^{″} )$$

Recall from above that r denotes the lateral position vector. yₘ(r) and yₘ₋₁(r) are the outgoing fields from the m-th and (m−1)-th sample layers, respectively. tₘ(r)=exp [j(2π/λ)Δz(nₘ(r)−n₀)] denotes the complex transmittance of the sample's m-th layer, where nₘ(r) is the 2D RI of the sample's m-th layer and n₀ is the RI of the surrounding media. h_{Δz}(r) designates the kernel for optical propagation by the distance Δz between sample layers and ⊗ represents the convolutional operator. In practice, convolution with the propagation kernel can be implemented in Fourier space via the angular spectrum method [49]. Thus, given a plane-wave incident to the first layer of the sample, y₀(r)=exp (jρ·r), the propagating field can be computed layer-by-layer via Eq. (5″) as it propagates through the sample. Recall from Eqs. (1) and (2) that p denotes the illumination beam's lateral wave-vector. The field y_{N}(r) exiting the last N-th sample layer contains the multiple-scattering effects that had accumulated as the wave propagated through the entire sample. The final intensity distribution at the camera plane can be expressed:

$$I ( r ) = {\vert {ℱ}^{- 1} \{ P ( u ) \cdot ℱ \{ {h}_{- \hat{z}} ( r ) ⊗ {y}_{N} ( r ) \} \} \vert}^{2} \qquad ( {6}^{″} )$$

We recall from Eqs. (1′)-(4′) that P(u) designates the pupil function of the imaging system, while [symbol] {·} and [symbol] {·} denote Fourier and inverse Fourier transform operators, respectively. \hat{z} denotes the distance between the N-th sample layer and the plane within the sample volume conjugate focused to the camera plane. Thus, for a given 3D RI distribution of the sample, MSBP can predict the measured intensity at the camera plane via Eqs. (5″) and (6″). In practice, we want to solve the inverse problem, where we predict the sample's 3D RI from scattering measurements. To improve the conditioning of this inverse problem, multiple measurements must be collected.

Similar to IDT, MSBP-based frameworks typically involve capturing multiple measurements of the sample under illumination from various angled plane waves, represented as

$${y}_{0}^{( ℓ )} ( r ) = exp ( j {ρ}^{( ℓ )} \cdot r ) .$$

Recall from Eqs. (1″) and (2″) that [symbol] denotes the lateral component of the [symbol] -th illumination beam's wave-vector. The corresponding intensity measurements are denoted as [symbol] (r). The RI reconstruction framework can then be formulated as a least-squares minimization that aims to minimize a loss term that captures the discrepancy between the measured amplitude and the predicted measurements:

$$\hat{n} ( {r}_{3 D} ) = {arg min}_{n ( {r}_{3 D} )} ℒ \qquad ( {7}^{″} )$$

$$where : ℒ = {\sum }_{ℓ = 1}^{L} {‖ \sqrt{{I}^{ℓ} ( r )} - \sqrt{{𝒢}^{( ℓ )} \{ n ( {r}_{3 D} ) \}} ‖}_{L 2}^{2} \qquad ( {8}^{″} )$$

Here, r_{3D}= [symbol] r, m [symbol] denotes a 3D spatial position vector, such that n(r_{3D}) represents the sample's complete 3D RI, i.e., n(r_{3D})=nₘ(r) for m=1, . . . , N. The operator ∥ . . . ∥_{L2} denotes the L2 norm. The operator [symbol] {·} denotes the MSBP forward model based on Eqs. (5″) and (6″), which predicts the measured intensity of a scattered field for a given 3D sample RI n(r_{3D}) and incident illumination field

$${y}_{0}^{( ℓ )} ( r )$$

Eq. (8″) defines a loss term L that aggregates together across all L measurements the differences between experimental measurements and predictions generated by the MSBP forward model. As shown in Eq. (7″), the reconstruction of the sample's 3D RI involves searching for a 3D distribution of n(r_{3D}) that minimizes [symbol] . In practice, this minimization process is performed iteratively using some variation of gradient descent. Only the real part of the refractive index is considered since the sample is non-absorptive, which simplifies the gradient derivation. To further stabilize the convergence of this iterative process, total-variation regularization is commonly applied.

### Experimental Results

Zebrafish care and use: A study was conducted to evaluate the proposed system. For imaging experiments involving zebrafish embryos, zebrafish derived from the wildtype AB strain were housed at UT Austin under an IACUC-approved protocol. Zebrafish embryos were staged according to established criteria [50].

Quantitative characterization: In order to validate the quantitative imaging capability of our imaging system, we reconstruct the 3D refractive index of silicon-dioxide and polystyrene microspheres, with 3 μm and 10 μm diameters, respectively, using IDT and MSBP. The 10 μm diameter polystyrene microspheres were immersed in index-matching oil (Cargille Standard Series Liquids) with RI of nₘ₁=1.5664 at the 660 nm center wavelength of our light source. Given that polystyrene has an RI of n_{Ps}=1.5855 at the same wavelength [51], the “ground-truth” microsphere-to-media RI difference for the polystyrene microspheres was Δn_{Ps}=n_{Ps}−nₘ₁=0.0191. Similarly, the 3 μm diameter silicon-dioxide microspheres were immersed in index-matching oil (Cargille Standard Series Liquids) with RI of nₘ₂=1.4376 at a center wavelength 660 nm. Silicon dioxide's RI is n_{SO2}=1.4563 at 660 nm wavelength-thus, the ground-truth microsphere-to-media RI difference for a 3 μm diameter silicon-dioxide microspheres is Δn_{SO2}=N_{SO2}−nₘ₂=0.0187.

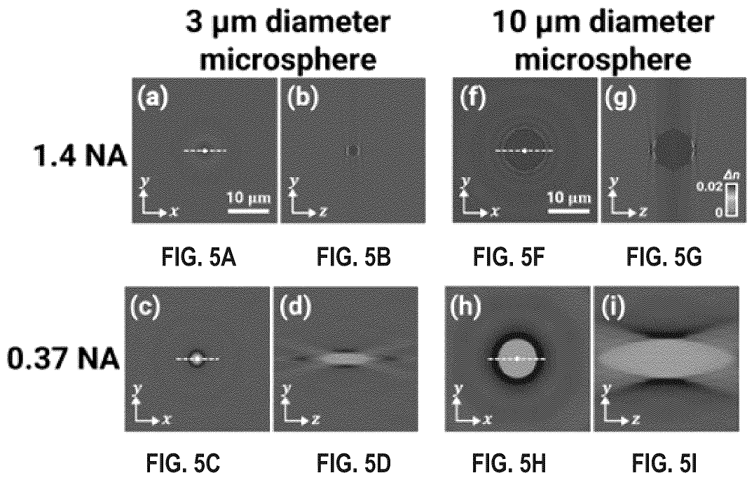

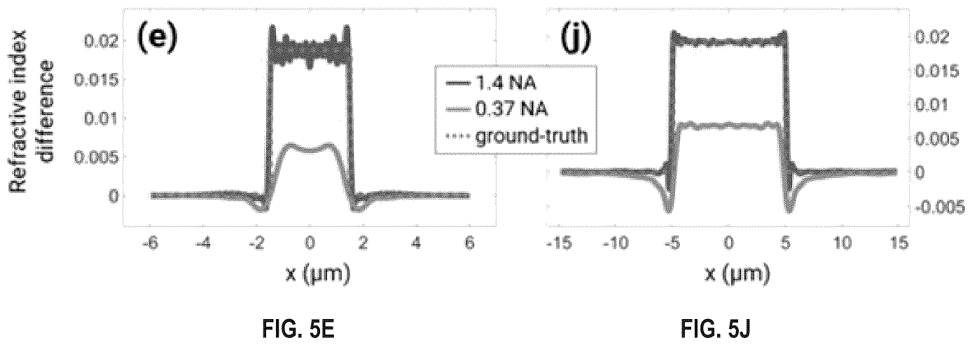

Simulation results: FIGS. 5A-5J show 3D RI of microspheres after imaging with low and high NA, simulated by Fourier filtering with NA-dependent OTF. For example, 3D RI of a 3 μm diameter microsphere imaged with (FIG. 5A, FIG. 5A) 1.4 NA is compared with that when imaged with (FIG. 5C, FIG. 5D) 0.37 NA. Similarly, 3D RI of the 10 μm diameter microsphere is compared when imaged with (FIG. 5F, FIG. 5G) 1.4 NA and (FIG. 5H, FIG. 5I) 0.37 NA. (FIG. 5E, FIG. 5J) Cross-sectional RI plots across the 3 μm and 10 μm microspheres, respectively, are shown and compared between 1.4 (blue) and 0.37 (green) NA, as well as with the ground truth RI difference (dashed red).

Notably, the numerical aperture (NA) of our imaging system is low, e.g., NA=0.37. This low NA will result in missing axial spatial frequencies (i.e., missing cone artifact) that degrade quantitative accuracy of the RI reconstruction. To compare the theoretical RI value that we expect to obtain using high-NA and low-NA systems, we simulate 3D RI reconstruction of both 10 μm (polystyrene) and 3 μm (silicon dioxide) diameter microspheres after Fourier filtering with the optical transfer function (OTF) [8] associated with NA=1.4 and NA=0.37. The corresponding lateral and axial views, along with RI cross-cut profiles across individual microspheres, are shown in FIGS. 5I-5J. We observed that both polystyrene and silicon dioxide microspheres, when filtered by the OTF associated with high 1.4 NA, exhibited reconstructed RI-difference values Δñps and Δñ_{SO2} that match well with ground-truth values Δñ_{PS} and Δn_{SO2}, respectively. However, the low 0.37 NA resulted in reduced axial resolution (i.e., the microsphere appears significantly elongated in the z direction), as well as a significant reduction in the reconstructed RI-difference of the polystyrene and silicon dioxide microspheres, measuring Δñ_{PS}=0.0068 and Δñ_{SO2}=0.0060, respectively. Given that this effect occurs purely due to low imaging NA, we consider these values for Δñ_{PS} and Δñ_{SO2} to be the theoretical RI-differences we expect to measure when reconstructing polystyrene and silicon dioxide microspheres, respectively, from measurements collected with our 0.37 NA system.

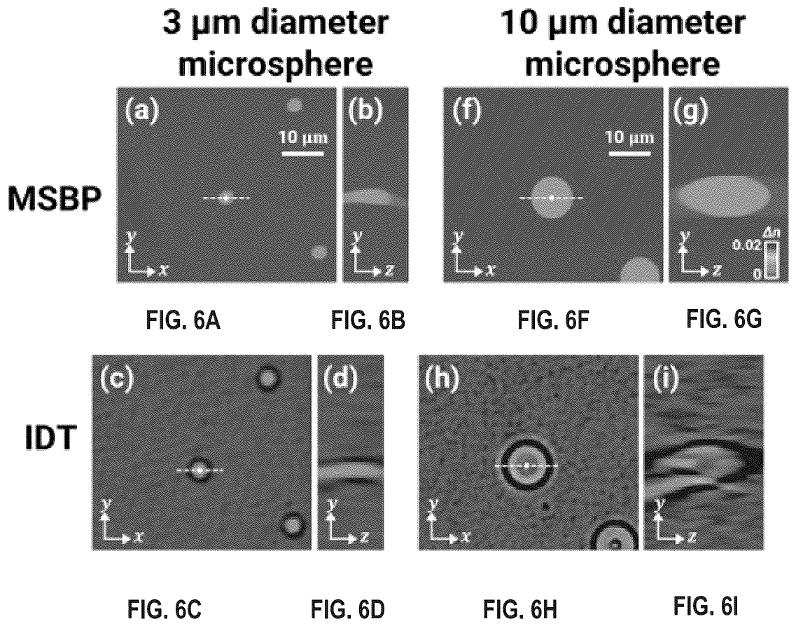

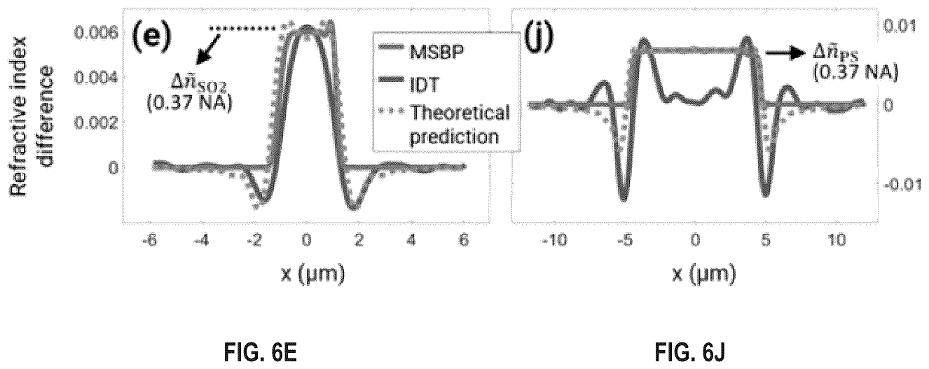

Experimental results: FIGS. 6A-6I show experimental 3D RI microsphere reconstructions with an imaging NA of 0.37. Lateral and axial cross-sections of 3 μm microspheres are shown when reconstructed with (FIG. 6A, FIG. 6B) MSBP and (FIG. 6C, FIG. 6D) IDT inverse-scattering reconstruction frameworks. Similarly, lateral and axial cross-sections of 10 μm microspheres are shown after reconstruction with (FIG. 6F, FIG. 6G) MSBP and (FIG. 6H, FIG. 6I) IDT. (FIG. 6E, FIG. 6J) Cross-sectional RI plots across the 3 μm and 10 μm microspheres, respectively, are shown and compared between MSBP- and IDT-based reconstructions. Plots indicating theoretical RI expectations are based on 0.37 NA OTF-filtering simulations in FIGS. 5A-5I discussed above.

Below, we compare IDT- and MSBP-based RI reconstructions on experimental datasets captured of 3 μm silicon dioxide and 10 μm polystyrene microspheres (see FIGS. 6A-6I). As shown in FIGS. 6A-6D, both MSBP- and IDT-based reconstructions can recover circular cross-sections of the 3 μm diameter silicon dioxide microspheres. FIG. 6E compares the profiles taken across the horizontal dashed lines in FIG. 6A and FIG. 6C, with the theoretical expectation Δñ_{SO2}=0.0060 based on the system's low 0.37 NA. For both IDT and MSBP-based reconstruction, good quantitative matching with Δñ_{SO2} was observed, with error of ˜1%. We conduct a similar analysis with the 10 μm polystyrene microspheres (see FIGS. 6F-6J). With these larger microspheres, however, we see that only MSBP yields good reconstruction. Specifically, MSBP-based reconstruction demonstrates quantitatively accurate RI-difference values that quantitatively match well with the theoretical prediction of Δñ_{PS}=0.0068, also within ˜1% error (see FIG. 6F and FIG. 6J). IDT-based reconstruction, however, demonstrates significant artifacts in the center of the microsphere (also seen in FIG. 6H and FIG. 6J) that deviate from theoretical predictions. This is an expected result because the IDT tomographic framework relies on the first Born approximation, which is known to be inaccurate for larger phase-objects spanning multiple microns [53, 54].

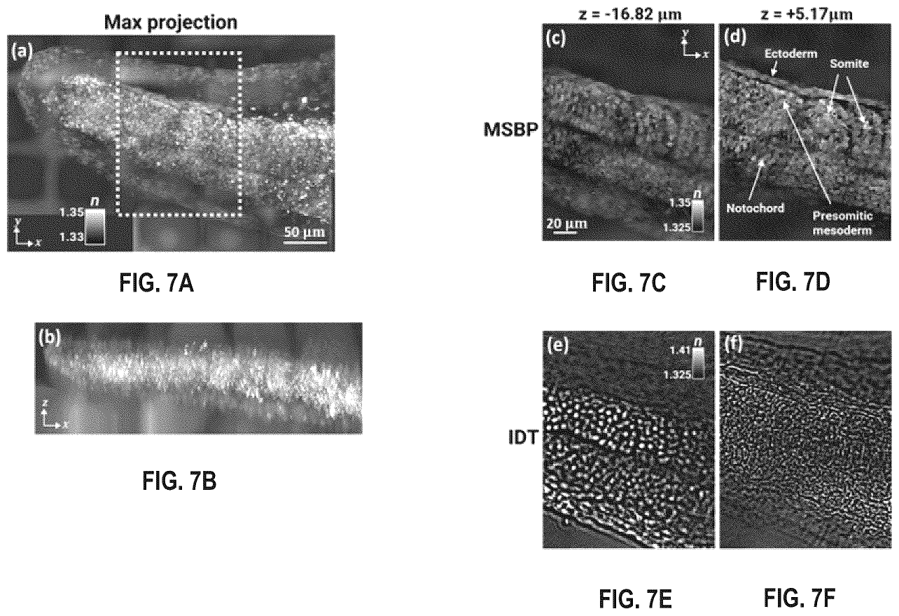

Zebrafish characterization: FIGS. 7A-7F show 3D RI reconstruction of a 24 hpf zebrafish embryo tail. FIG. 7A and FIG. 7B show x-y and x-z max-projection images, respectively, based on the 3D RI values reconstructed with MSBP. From the selected region indicated with dashed white rectangle in FIG. 7A, lateral zooms of zebrafish morphology are shown based on RI values reconstructed with (FIG. 7C and FIG. 7D) MSBP and (FIG. 7E and FIG. 7F) IDT, at axial positions z=−16.82 μm and +5.17 μm, respectively. Various anatomical structures are identified in FIG. 7D.

We next explore the system's imaging capabilities for imaging multiple-scattering samples. We specifically image a 24 hour-post-fertilization (hpf) zebrafish embryo, which is known to be moderately scattering, immersed in PBS solution. We 3D reconstruct the embryo's tail region using both IDT and MSBP, as depicted in FIGS. 7A-7F. FIG. 7A and FIG. 7B show the max projection of the MSBP reconstruction across x-y and x-z cross-sectional planes, respectively. FIGS. 7C-7D and FIGS. 7E-7F show lateral cross-sectional zooms reconstructed by MSBP and IDT, respectively, of the outlined region in FIG. 7A. Notably, due to the zebrafish sample's multiple scattering, reconstruction with the weak-scattering IDT framework is unable to recover important internal features and instead highlights only edges. This observation matches that made by previous works as well [5, 35, 53, 54]. In contrast, MSBP-based reconstruction clearly visualizes important structural and morphological features in the zebrafish tail, such as the ectoderm, somites, presomitic mesoderm and notochord (see FIG. 5D). The ectoderm region demonstrated RI values ranging from 1.332 to 1.344. The notochord region demonstrated RI values ranging from 1.332 to 1.345. The somites and presomitic mesoderm region demonstrated RI values ranging from 1.334 to 1.349. Notably, based on the low NA of our imaging system and our simulated findings depicted previously in FIGS. 5A-5J, we expect these reconstructed RI values to be lower than the true physiological RI values within the zebrafish tail region. However, the general anatomy of the zebrafish tail can be clearly visualized, and results from other works can be used to compensate for low imaging NA to achieve quantitatively accurate RI reconstructions [55-57].

### Discussion

We have introduced a novel hardware design for optical diffraction tomography that uses a DMD and microlens array (MLA) as a programmatic module for scanning illumination angles. In this particular work, our acquisition frame-rate was limited by the camera speed to 125 Hz (resulting in a volumetric frame-rate of 0.74 Hz), but future extensions will explore the use of ultrafast cameras operating up to the DMD's binary frame-rate of 10 kHz. To achieve high image quality at such high frame-rates, methods to improve SNR will also be explored, such as using a higher-power light source or realigning the DMD to meet the blaze condition [38, 58]. Using a higher-resolution (i.e., larger NA) imaging lens would also increase light collection efficiency, in addition to increasing lateral and axial optical resolution as well as quantitative accuracy of RI reconstruction. In this work, however, we selected our imaging lenses to prioritize large FOV instead of high resolution (i.e., high NA) since our long-term goal is to achieve inverse-scattering of large-scale multiple-scattering samples.

Another extension to our work would be to formulate a methodology to select or design MLAs optimized for specific classes of ODT applications. Notably, with our proposed system design, the MLA defines which illumination angles can be incident to the sample. In the particular image applications demonstrated in this work, we found empirically that we need only activate a quarter of all available microlenses in the MLA to achieve high-quality 3D RI reconstructions. An MLA more optimally designed for these image applications would presumably consist of a lower density of microlenses that are larger in size, which would direct a larger portion of the total incident light into the same illumination angles we used, achieving a better tradeoff in SNR versus acquisition time. However, one could envision an opposite optimal tradeoff in the case of more highly scattering samples, where it would be more beneficial to have more illumination angles (i.e., higher density of microlenses), even at the expense of microlens size (i.e., less optical power per illumination angle). Additionally, optimizing the arrangement of individual microlenses within the MLA represents another useful design aspect. For example, previous works have shown that not all illumination angles are equally important for robust phase-retrieval when reconstructing from angle-specific scattering measurements [16, 22]. Thus, customized design of individual microlenses in non-standard configurations may be another important design parameter to optimize imaging performance.

Another powerful extension is to leverage our system's ability to activate multiple microlenses simultaneously, enabling multiple illumination angles to be incident to the sample at once. After combining with new computational frameworks designed to unmix scattering information multiplexed into each raw measurement, this strategy for “coded” illumination dramatically decreases the total number of captured measurements, thus increasing volumetric frame-rate. For example, recent works by Matlock et al. and Sun et al. used a coded illumination strategy with LED arrays to increase volumetric frame-rates by multiple factors. He et al. and Ge et al. showed that a similar coded-illumination concept can be applied with high-resolution imaging lenses and interferometric setups, achieving frame-rates up to 8 kHz and 10 kHz respectively. Similar coded illumination methodologies may also be applied to our work here, which represents an exciting computational approach to dramatically increasing acquisition speed and expanding the application of our proposed system to real-time imaging of live biological samples.

### CONCLUSION

In this work, we have introduced a novel switchable angle-scanning module for ODT, based on DMD and MLA. Compared with angle-scanning strategies for standard ODT systems, our method avoids mechanical scanning and balances scanning speed with power efficiency. We demonstrate the imaging capability of our system by reconstructing microspheres and a multiple-scattering early-stage zebrafish embryo. We show that image reconstructions with data collected by our system can achieve high quantitative accuracy, as benchmarked by theoretical expectations based on the system's NA. Our system currently achieves a data acquisition speed of 125 Hz, corresponding to a volumetric frame-rate of 0.74 Hz. This relatively low speed is limited by our current camera's frame-rate, and future iterations of this system will utilize ultrafast cameras operating up to the DMD's maximum frame-rate, enabling real-time volumetric acquisition. We envision this proposed system to find significant application in live-imaging dynamic multiple scattering samples.

### Example Computing Device

It should be appreciated that the logical operations described herein with respect to the various figures may be implemented (1) as a sequence of computer-implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special-purpose digital logic, and any combination thereof. It should also be appreciated that more or fewer operations may be performed than shown in the figures and described herein. These operations may also be performed in a different order than those described herein.

Referring to FIG. 8, an example computing device 800 upon which embodiments of the present disclosure may be implemented is illustrated. It should be understood that the example computing device 800 is only one example of a suitable computing environment upon which embodiments of the present disclosure may be implemented. Optionally, the computing device 800 can be a well-known computing system including, but not limited to, personal computers, servers, handheld or laptop devices, multiprocessor systems, microprocessor-based systems, personal network computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, the computing device 800 typically includes at least one processing unit 806 and system memory 804. Depending on the exact configuration and type of computing device, system memory 804 may be volatile (such as random-access memory (RAM)), non-volatile (such as read-only memory (ROM), flash memory, etc.), or some combination of the two. This most basic configuration is illustrated in FIG. 8 by the dashed line 802. The processing unit 806 may be a standard programmable processor that performs arithmetic and logic operations necessary for the operation of the computing device 800. The computing device 800 may also include a bus or other communication mechanism for communicating information among various components of the computing device 800.

Computing device 800 may have additional features/functionality. For example, the computing device 800 may include additional storage such as removable storage 808 and non-removable storage 810 including, but not limited to magnetic or optical disks or tapes. Computing device 800 may also contain network connection(s) 816 that allow the device to communicate with other devices. Computing device 800 may also have input device(s) 814 such as a keyboard, mouse, touch screen, etc. Output device(s) 812, such as a display, speakers, printer, etc., may also be included. The additional devices may be connected to the bus in order to facilitate communication of data among the components of the computing device 800. All these devices are well-known in the art and need not be discussed at length here.

The processing unit 806 may be configured to execute program code encoded in tangible, computer-readable media. Tangible, computer-readable media refers to any media that is capable of providing data that causes the computing device 800 (i.e., a machine) to operate in a particular fashion. Various computer-readable media may be utilized to provide instructions to the processing unit 806 for execution. Example of tangible, computer-readable media may include but is not limited to, volatile media, non-volatile media, removable media and non-removable media implemented in any method or technology for storage of information such as computer-readable instructions, data structures, program modules or other data. System memory 804, removable storage 808, and non-removable storage 810 are all examples of tangible computer storage media. Examples of tangible, computer-readable recording media include but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 806 may execute program code stored in the system memory 804. For example, the bus may carry data to the system memory 804, from which the processing unit 806 receives and executes instructions. The data received by the system memory 804 may optionally be stored on the removable storage 808 or the non-removable storage 810 before or after execution by the processing unit 806.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an application programming interface (API), reusable controls, or the like. Such programs may be implemented in a high-level procedural or object-oriented programming language to communicate with a computer system. However, the program(s) can be implemented in assembly or machine language if desired. In any case, the language may be a compiled or interpreted language, and it may be combined with hardware implementations.

In one embodiment, disclosed herein is a non-transitory computer-readable storage medium comprising instructions that, when executed, cause at least one processor to perform the method of any preceding embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The following patents, applications and publications as listed below and throughout this document are hereby incorporated by reference in their entirety herein.

### REFERENCE LIST 1

1. U. Kubitscheck, Fluorescence microscopy: from principles to biological applications (John Wiley & Sons, 2017).
2. J. Icha, M. Weber, J. C. Waters, and C. Norden, “Phototoxicity in live fluorescence microscopy, and how to avoid it,” BioEssays 39, 1700003 (2017).
3. B. Bhaduri, C. Edwards, H. Pham et al., “Diffraction phase microscopy: principles and applications in materials and life sciences,” Advances in Optics and Photonics 6, 57-119 (2014).
4. Y. Park, C. Depeursinge, and G. Popescu, “Quantitative phase imaging in biomedicine,” Nature photonics 12, 578-589 (2018).
5. Y. Sung, W. Choi, C. Fang-Yen et al., “Optical diffraction tomography for high resolution live cell imaging,” Optics Express 17, 266-277 (2009).
6. K. Kim, K. S. Kim, H. Park et al., “Real-time visualization of 3-D dynamic microscopic objects using optical diffraction tomography,” Optics express 21, 32269-32278 (2013).
7. J. Lim, A. B. Ayoub, E. E. Antoine, and D. Psaltis, “High-fidelity optical diffraction tomography of multiple scattering samples,” Light: Science & Applications 8, 82 (2019).
8. V. Lauer, “New approach to optical diffraction tomography yielding a vector equation of diffraction tomography and a novel tomographic microscope,” Journal of microscopy 205, 165-176 (2002).
9. W. Choi, C. Fang-Yen, K. Badizadegan et al., “Tomographic phase microscopy,” Nature methods 4, 717-719 (2007).
10. T. H. Nguyen, M. E. Kandel, M. Rubessa et al., “Gradient light interference microscopy for 3D imaging of unlabeled specimens,” Nature communications 8, 210 (2017).
11. X. Chen, M. E. Kandel, C. Hu et al., “Wolf phase tomography (WPT) of transparent structures using partially coherent illumination,” Light: Science & Applications 9, 142 (2020).
12. X. Chen, M. E. Kandel, S. He et al., “Artificial confocal microscopy for deep label-free imaging,” Nature photonics 17, 250-258 (2023).
13. S. Zhou, J. Li, J. Sun et al., “Transport-of-intensity Fourier ptychographic diffraction tomography: defying the matched illumination condition,” Optica 9, 1362-1373 (2022).
14. J. M. Soto, J. A. Rodrigo, and T. Alieva, “Label-free quantitative 3D tomographic imaging for partially coherent light microscopy,” Optics Express 25, 15699-15712 (2017).
15. J. A. Rodrigo, J. M. Soto, and T. Alieva, “Fast label-free microscopy technique for 3D dynamic quantitative imaging of living cells,” Biomedical optics express 8, 5507-5517 (2017).
16. A. Matlock and L. Tian, “High-throughput, volumetric quantitative phase imaging with multiplexed intensity diffraction tomography,” Biomedical optics express 10, 6432-6448 (2019).
17. R. Horstmeyer, J. Chung, X. Ou et al., “Diffraction tomography with Fourier ptychography,” Optica 3, 827-835 (2016).
18. R. Ling, W. Tahir, H.-Y. Lin et al., “High-throughput intensity diffraction tomography with a computational microscope,” Biomedical optics express 9, 2130-2141 (2018).
19. J. Zhu, H. Wang, and L. Tian, “High-fidelity intensity diffraction tomography with a non-paraxial multiple-scattering model,” Optics Express 30, 32808-32821 (2022).
20. C. Zuo, J. Sun, J. Li et al., “Wide-field high-resolution 3D microscopy with Fourier ptychographic diffraction tomography,” Optics and Lasers in Engineering 128, 106003 (2020).
21. Z. Tong, X. Ren, Z. Zhang et al., “Three-dimensional refractive index microscopy based on the multi-layer propagation model with obliquity factor correction,” Optics and Lasers in Engineering 174, 107966 (2024).
22. J. Li, A. Matlock, Y. Li et al., “High-speed in vitro intensity diffraction tomography,” Advanced Photonics 1, 066004-066004 (2019).
23. M. Sun, L. Shao, J. Zhang et al., “High-resolution 3D Fourier ptychographic reconstruction using a hemispherical illumination source with multiplexed-coded strategy,” Biomedical Optics Express 13, 2050-2067 (2022).
24. M. R. Kellman, E. Bostan, N. A. Repina, and L. Waller, “Physics-based learned design: optimized coded-illumination for quantitative phase imaging,” IEEE Transactions on Computational Imaging 5, 344-353 (2019).
25. L. Tian, X. Li, K. Ramchandran, and L. Waller, “Multiplexed coded illumination for Fourier Ptychography with an LED array microscope,” Biomedical optics express 5, 2376-2389 (2014).
26. S. Sen, I. Ahmed, B. Aljubran et al., “Fourier ptychographic microscopy using an infrared-emitting hemispherical digital condenser,” Applied Optics 55, 6421-6427 (2016).
27. Z. F. Phillips, M. V. D′Ambrosio, L. Tian et al., “Multi-contrast imaging and digital refocusing on a mobile microscope with a domed LED array,” PloS one 10, e0124938 (2015).
28. K. Lee, K. Kim, G. Kim et al., “Time-multiplexed structured illumination using a DMD for optical diffraction tomography,” Optics letters 42, 999-1002 (2017).
29. S. Chowdhury, W. J. Eldridge, A. Wax, and J. Izatt, “Refractive index tomography with structured illumination,” Optica 4, 537-545 (2017).
30. S. Shin, K. Kim, J. Yoon, and Y. Park, “Active illumination using a digital micromirror device for quantitative phase imaging,” Optics letters 40, 5407-5410 (2015).
31. D. Jin, R. Zhou, Z. Yaqoob, and P. T. C. So, “Dynamic spatial filtering using a digital micromirror device for high-speed optical diffraction tomography,” Optics express 26, 428-437 (2018).
32. Y. He, Y. Wang, and R. Zhou, “Digital micromirror device based angle-multiplexed optical diffraction tomography for high throughput 3D imaging of cells,” in (SPIE, 1129402.
33. C. Kuang, Y. Ma, R. Zhou et al., “Digital micromirror device-based laser-illumination Fourier ptychographic microscopy,” Optics express 23, 26999-27010 (2015).
34. P. T. Brown, L. Meneses, E. Monakhova et al., “Fourier synthesis optical diffraction tomography for kilohertz rate volumetric imaging,” arXiv preprint arXiv: 2309.16912 (2023).
35. S. Chowdhury, M. Chen, R. Eckert et al., “High-resolution 3D refractive index microscopy of multiple-scattering samples from intensity images,” Optica 6, 1211-1219 (2019).
36. J. A. Izatt and M. A. Choma, “Theory of optical coherence tomography,” in Optical Coherence Tomography: Technology and Applications (Springer, 2008), pp. 47-72.
37. Y. X. Ren, R. D. Lu, and L. Gong, “Tailoring light with a digital micromirror device,” Annalen der physik 527, 447-470 (2015).
38. X. Chen, B.-b. Yan, F.-j. Song et al., “Diffraction of digital micromirror device gratings and its effect on properties of tunable fiber lasers,” Applied Optics 51, 7214-7220 (2012).
39. H. Gross, “Handbook of Optical Systems,” (2005).
40. J. Sun, Q. Chen, Y. Zhang, and C. Zuo, “Efficient positional misalignment correction method for Fourier ptychographic microscopy,” Biomedical optics express 7, 1336-1350 (2016).
41. F. Zhang, I. Peterson, J. Vila-Comamala et al., “Translation position determination in ptychographic coherent diffraction imaging,” Optics express 21, 13592-13606 (2013).
42. A. Pan, Y. Zhang, T. Zhao et al., “System calibration method for Fourier ptychographic microscopy,” Journal of biomedical optics 22, 096005-096005 (2017).
43. R. Eckert, Z. F. Phillips, and L. Waller, “Efficient illumination angle self-calibration in Fourier ptychography,” Applied optics 57, 5434-5442 (2018).
44. M. Chen, D. Ren, H.-Y. Liu et al., “Multi-layer Born multiple-scattering model for 3D phase microscopy,” Optica 7, 394-403 (2020).
45. A. M. Jiaji Li, Yunzhe Li, Qian Chen, Chao Zuo and Lei Tian, “IDT-using-Annular-Illumination”, retrieved https://github.com/bu-cisl/IDT-using-Annular-Illumination.
46. M. C. Shwetadwip Chowdhury, Regina Eckert, David Ren, Fan Wu, Nicole Repina, and Laura Waller, “multi-slice”, retrieved https://github.com/Waller-Lab/multi-slice.
47. M. Born and E. Wolf, “Basic properties of the electromagnetic field,” Principles of optics 44, 1-70 (1980).
48. U. S. Kamilov, I. N. Papadopoulos, M. H. Shoreh et al., “Optical tomographic image reconstruction based on beam propagation and sparse regularization,” IEEE Transactions on Computational Imaging 2, 59-70 (2016).
49. J. W. Goodman, Introduction to Fourier optics (Roberts and Company publishers, 2005).
50. C. B. Kimmel, W. W. Ballard, S. R. Kimmel et al., “Stages of embryonic development of the zebrafish,” Developmental dynamics 203, 253-310 (1995).
51. N. Sultanova, S. Kasarova, and I. Nikolov, “Dispersion properties of optical polymers,” Acta Physica Polonica A 116, 585-587 (2009).
52. I. H. Malitson, “Interspecimen comparison of the refractive index of fused silica,” Josa 55, 1205-1209 (1965).
53. K. Iwata and R. Nagata, “Calculation of refractive index distribution from interferograms using the Born and Rytov's approximation,” Japanese Journal of Applied Physics 14, 379 (1975).
54. B. Chen and J. J. Stamnes, “Validity of diffraction tomography based on the first Born and the first Rytov approximations,” Applied optics 37, 2996-3006 (1998).
55. J. Lim, K. Lee, K. H. Jin et al., “Comparative study of iterative reconstruction algorithms for missing cone problems in optical diffraction tomography,” Optics express 23, 16933-16948 (2015).
56. H. Chung, J. Huh, G. Kim et al., “Missing cone artifact removal in ODT using unsupervised deep learning in the projection domain,” IEEE Transactions on Computational Imaging 7, 747-758 (2021).
57. K. C. Zhou and R. Horstmeyer, “Diffraction tomography with a deep image prior,” Optics express 28, 12872-12896 (2020).
58. P. T. Brown, R. Kruithoff, G. J. Seedorf, and D. P. Shepherd, “Multicolor structured illumination microscopy and quantitative control of polychromatic light with a digital micromirror device,” Biomedical Optics Express 12, 3700-3716 (2021).
59. B. Ge, Y. He, M. Deng et al., “Single-frame label-free cell tomography at speed of more than 10,000 volumes per second,” arXiv preprint arXiv: 2202.03627 (2022).

### REFERENCE LIST 2

1. T. Stangner, H. Zhang, T. Dahlberg et al., “Step-by-step guide to reduce spatial coherence of laser light using a rotating ground glass diffuser,” Applied optics 56, 5427-5435 (2017).
2. Y. Kuratomi, K. Sekiya, H. Satoh et al., “Speckle reduction mechanism in laser rear projection displays using a small moving diffuser,” JOSA A 27, 1812-1817 (2010).
3. D. S. Mehta, D. N. Naik, R. K. Singh, and M. Takeda, “Laser speckle reduction by multimode optical fiber bundle with combined temporal, spatial, and angular diversity,” Applied optics 51, 1894-1904 (2012).

What is claimed:

1. A three-dimensional (3D) imaging system comprising:
a light delivery component configured to condition a light beam to illuminate a sample with multiple angled plane waves simultaneously;
a fully-switchable angle scanning component operatively coupled to the light delivery component configured to scan the illuminated sample at a plurality of illumination angles or imaging configurations or imaging configurations simultaneously;
an imaging component configured to capture a plurality of two-dimensional (2D) images at each of the plurality of illumination angles or imaging configurations; and
at least one processor configured to:
determine, using a layer-by-layer decomposition operation and based, at least in part, on 3D refractive index initial guess, one or more transmittance properties (e.g., propagation kernel and complex transmittance) including a transmittance magnitude and phase shift as the light beam passes through the sample at each of the plurality of illumination angles or imaging configurations,
simulate 2D acquisition images based on the one or more transmittance properties, and
reconstruct 3D refractive index to generate a 3D image of the sample by iteratively minimizing a difference between the simulated 2D images and the captured 2D images.

2. The 3D imaging system of claim 1, wherein the at least one processor is further configured to:
reconstruct the 3D refractive index to generate the 3D image by iteratively applying a multi-slice beam propagation (MSBP) or MSBP forward model operation.

3. The 3D imaging system of claim 1, wherein the at least one processor is further configured to attenuate noise and poor conditioning by:
implementing a 3D total-variation (TV) regularization operation.

4. The 3D imaging system of claim 1, wherein the light delivery component comprises:
at least one of a rotating diffuser;
at least one focusing lens; and
a multimode fiber operatively coupled to one or more vibrational motors.

5. The 3D imaging system of claim 4, wherein:
the at least one rotating diffuser is configured to scatter the light beam, and
the at least one focusing lens is configured to collect the scattered light beam and focus it into the multimode fiber.

6. The 3D imaging system of claim 5, wherein the multimode fiber is configured to scramble or further disperse the scattered/focused light beam using the one or more vibrational motors.

7. The 3D imaging system of claim 1, wherein the fully-switchable angle scanning component comprises a digital micromirror device (DMD) element and a microlens array.

8. The 3D imaging system of claim 7, wherein the DMD element comprises a plurality of micromirrors that are each configured to switch between an on-state and an off-state.

9. The 3D imaging system of claim 8, wherein, in an on-state, a respective subset of the plurality of micromirrors is configured to generate a focal point on a corresponding location of the microlens array at one or more predetermined angles.

10. The 3D imaging system of claim 9, wherein the one or more predetermined angles comprise between two and twenty predetermined angles.

11. The 3D imaging system of claim 9, wherein each respective subset comprises a plurality of micromirror patches that each, in the on-state, generates a respective focal point on a single microlens of the microlens array.

12. The 3D imaging system of claim 11, wherein each of the plurality of micromirror patches is circular.

13. The 3D imaging system of claim 11, wherein scanning the illuminated sample at a plurality of illumination angles or imaging configurations comprises multiplexing the plurality of illumination angles by simultaneously switching through the plurality of micromirror patches.

14. The 3D imaging system of claim 9, wherein each respective subset of the plurality of micromirrors is activated sequentially.

15. The 3D imaging system of claim 1, wherein the at least one processor is further configured to:
calibrate incident angles of the plane wave illumination beams using an angle-calibration operation.

16. A method comprising:
illuminating a sample with a light beam, wherein the light beam is delivered by a light delivery component;
scanning, via a fully-switchable angle scanning component, the illuminated sample at a plurality of illumination angles or imaging configurations simultaneously;
capturing, via an imaging component, a plurality of two-dimensional images at each of the plurality of illumination angles or imaging configurations;
determining, using a layer-by-layer decomposition operation and based, at least in part, on 3D refractive index initial guess, one or more transmittance properties including a transmittance magnitude and phase shift as the light beam passes through the sample at each of the plurality of illumination angles or imaging configurations;
simulating 2D acquisition images based on the one or more transmittance properties; and
reconstructing 3D refractive index to generate a 3D image of the sample by iteratively minimizing a difference between the simulated 2D images and the captured 2D images.

17. The method of claim 16, further comprising:
implementing, by at least one processor, a 3D total-variation (TV) regularization operation to attenuate noise and poor conditioning.

18. A three-dimensional (3D) imaging system comprising:
a light delivery component configured to condition a light beam to illuminate a sample with multiple angled plane waves simultaneously;
a fully-switchable angle scanning component operatively coupled to the light delivery component configured to scan the illuminated sample at a plurality of illumination angles or imaging configurations simultaneously; and
an imaging component configured to capture a plurality of two-dimensional (2D) images at each of the plurality of illumination angles or imaging configurations, wherein the light delivery component comprises at least one of a rotating diffuser, at least one focusing lens, and a multimode fiber operatively coupled to one or more vibrational motors.

19. The 3D imaging system of claim 18, wherein:
the at least one rotating diffuser is configured to scatter the light beam, and
the at least one focusing lens is configured to collect the scattered light beam and focus it into the multimode fiber.

20. The 3D imaging system of claim 19, wherein the multimode fiber is configured to scramble or further disperse the scattered/focused light beam using the one or more vibrational motors.
